(19) United States
(12) Patent Application Publication
(10) Pub. No.: US 2015/0119245 A1
(43) Pub. Date: Apr. 30, 2015

(54) Method for Producing Shelf Stable Hypochlorous Acid Solutions

(71) Applicant: EIJ Industries, Inc., Romeoville, IL (US)

(72) Inventors: Pollis Robertson, JR., Bolingbrook, IL (US); Paul Theruviparampil, Lynwood, IL (US); Louis Bailey, Plainfield, IL (US)

(73) Assignee: EIJ Industries, Inc., Romeoville, IL (US)

(21) Appl. No.: 14/263,302

(22) Filed: Apr. 28, 2014

Related U.S. Application Data
(60) Provisional application No. 61/895,927, filed on Oct. 25, 2013.

(51) Int. Cl. C25B 1/46; A01N 3/02; A01N 59/00

(52) U.S. Cl. CPC C25B 1/46; A01N 59/00; A01N 3/02
USPC 504/114; 205/351; 252/175; 424/661

(57) ABSTRACT

A method for production and storage of hypochlorous acid is disclosed. The method comprises using high purity water achieved by a combination of softening and reverse osmosis steps. The shelf life is further improved by storing the hypochlorous acid in opaque PET bottles or Nylon/PE bags or nylon bags in a box. Solutions stored in opaque PET bottles exhibit the best stability. Anticipated uses of the extended life hypochlorous acid solution include sanitizer for food contact and non-food contact surfaces, a streak-free cleaner for smooth surfaces and a cut flower life extender. Other biocide uses include water treatment in oil and gas production, cooling tower, lazy river and swimming pools, process water distribution systems, drinking water, portable humidifier, fish tanks and treatment of metalworking fluids and lubricants.

### CROSS-REFERENCE TO RELATED APPLICATIONS

This application relates to and claims priority from U.S. Provisional Patent Application Ser. No. 61/895,927 filed Oct. 25, 2013.

### FIELD OF THE INVENTION

An improved method for production and storage of hypochlorous acid is disclosed. Typically hypochlorous acid is produced by the electrolysis of a brine (NaCl) solution. The invention discloses an improved production method for hypochlorous acid resulting in improved shelf life. The improved production method comprises using high purity water achieved by a combination of softening and reverse osmosis steps. The shelf life is further improved by storing the hypochlorous acid in opaque PET bottles or Nylon/PE bags in a box. The greatest improvement in shelf life is demonstrated with opaque PET bottles. Anticipated uses of the extended life hypochlorous acid solution include sanitizer for food contact and non-food contact surfaces, a streak-free cleaner for smooth surfaces, as a biocide in the oil and gas industry, as a water treatment in various applications and a cut flower life extender.

### BACKGROUND OF THE DISCLOSURE

Hypochlorous acid is a non-toxic, all natural, biodegradable cleaner, sanitizer and disinfectant. It is naturally produced in the human body immune system to fight infection. White blood cells release this natural oxidant to kill bacteria, viruses and fungal spores.

Hypochlorous acid has long been considered to have a limited shelf-life of a few months and so has been produced on-site by the electrolysis of a brine solution in healthcare and food processing settings.

Because of the non-toxic nature of hypochlorous acid solutions, there is a need for a method of production and storage that would result in a product suitable for the consumer market. Anticipated applications include sanitizing and disinfecting solutions suitable for household use for items that come into contact with children and pets. Other applications would take advantage of the non-toxic-antibacterial qualities to improve the shelf life of flowers. Other uses comprise a streak-free cleaner.

There is need for an improved shelf life hypochlorous acid. As can be seen, there are a vast array of efforts already existing to provide a solution to the problems confronted when storing hypochlorous acid, but none provides the combination of features and advantages presented in the instant disclosure.

These references include: U.S. Pat. No. 7,517,568 entitled “Packaging for Dilute Hypochlorite,” issued to Bitowft et al. on Apr. 14, 2009; U.S. Pat. No. 7,323,118 entitled “Composition of Hypochlorous Acid and Its Applications,” was issued to Calderon on Jan. 29, 2008; U.S. Pat. No. 7,276,255 entitled “Wound and Ulcer Treatment with Super-Oxidized Water,” issued to Selkon on Oct. 2, 2007; U.S. Pat. No. 5,322,677 entitled “Process for Producing Concentrated Hypochlorous Acid Solutions,” issued to Shaffer, et al. on Jun. 21, 1994; U.S. Pat. No. 5,108,560 entitled “Electrochemical Process for Production of Chloric Acid from Hypochlorous Acid,” issued to Cawlfield et al. on Apr. 28, 1992; U.S. Pat. No. 4,190,638 entitled “Production of Hypochlorous Acid,” issued to Hoekje, et al. on Feb. 26, 1980; U.S. Pat. No. 4,065,545 entitled “Stabilized Hypochlorous Acid and Hypochlorite Solutions,” issued to Gamlen on Dec. 27, 1977; U.S. Pat. No. 2,111,194 entitled “Method of Producing Hypochlorous Acid Solution,” issued to Sanchez on Mar. 15, 1938; U.S. Pat. No. 1,732,230 entitled “Production of Solid Stable Hypochlorites Yielding Hypochlorous Acid,” issued to Hershman, on Oct. 22, 1929; U.S. Patent Application Publication No. 2013/0216628 entitled “Compositions of Hypochlorous Acid (HOCl) and Methods of Manufacture Thereof,” published on behalf of Hinderson et al. on Aug. 22, 2013; U.S. Patent Application Publication No. 2013/0146472 entitled “Apparatus and Method for Generating a Stabilized Sanitizing Solution,” published on behalf of Sullivan et al. on Jun. 13, 2013; U.S. Patent Application Publication No. 2012/0269904 entitled “Solution Containing Hypochlorous Acid and Methods of Using Same,” published on behalf of Northey on Oct. 25, 2012; U.S. Patent Application Publication No. 2012/0267256 entitled, “Independent Production of Electrolyzed Acid Water and Electrolyzed Basic Water,” published on behalf of Kindred on Oct. 25, 2012; U.S. Patent Application Publication No. 2012/0237616 entitled “Stabilized Hypohalous Acid Solutions,” published on behalf of Panicheva et al. on Sep. 20, 2012; U.S. Patent Application Publ. No. 2012/0073983 entitled “Producing Apparatus and Producing Method of Hypochlorous Acid Water,” published on behalf of Tomita, et al. on Mar. 29, 2012;U.S. Patent Application Publication No. 2011/0256243 entitled “System and Method for Preparation of Antimicrobial Solutions,” published on behalf of Van Kalken et al. on Oct. 20, 2011; U.S. Patent Application Publication No. 2010/0310672 entitled “Disinfectant Based on Aqueous, Hypochlorous Acid (HOCl)-Containing Solutions; Method for the Production Thereof and Use Thereof,” published on behalf of Beltrup et al. on Dec. 9, 2010 [issued as European Patent No. EP 2146580 entitled “Use of a Disinfectant Based on Aqueous, Hypochlorous Acid (HOCl)-Containing Solutions,” on Jan. 27, 2010]; U.S. Patent Application Publication No. 2009/0081077 entitled “Alkaline Water Sterilizer and Alkaline Sterilizing Water Production Method,” published on behalf of Sawada on Mar. 26, 2009; U.S. Patent Application Publication No. 2005/0232847 entitled “Method for Diluting Hypochlorite,” published on behalf of Bromberg et al. on Oct. 20, 2005; WIPO Patent Application Publication No. WO 2013/134327 A1 entitled “Disinfectant Solution,” published on behalf of Lin, et al. on Sep. 12, 2013; WIPO Patent Application Publication No. WO 2012/123695 A2 entitled “A Stable Composition of HOCl, Processes for Its Production and Uses Thereof,” published on behalf of Mallet, et al. on Sep. 20, 2012; WIPO Patent Application Publication No. WO 2012/041357 A1 entitled “Method for Producing a Disinfectant Based on Hypochlorous Acid or Hypochlorite by Electrochemical Activation of a Chloride Solution,” published on behalf of Fischer et al. on Apr. 5, 2013; European Patent Application Publ. No. 2 277 827 A2 entitled “Method of Producing Composition of Hypochlorous Acid and Use Thereof,” published on behalf of Calderon on Jan. 26, 2011. WIPO Patent Application Publication No. WO 2010/025276 A1 entitled “Container and Dispenser,” published on behalf of Ivers, et al. on Mar. 4, 2012; WIPO Patent Application Publication No. WO 2007/070637 A2 entitled “Method of Treating Open Wounds Using Hypochlorous Acid,” published on behalf of Selkon, on Jun. 21, 2007; European Patent Application Publication No. EP 1 721 868 Al entitled “Additive Solution for Use in the Production of Electrolyzed Hypochlorous Acid-Containing Sterilizing Water,” published on behalf of Yukawa on Nov. 15, 2006; Chapter in book “Aqueous Antimicrobial Treatments to Improve Fresh and Fresh-Cut Produce Safety,” by Herdt et al; in Microbial Safety of Fresh Produce (2009): 169; http://www.researchgate.net/publication/228014922_Biological_Control_of_Human_Pathogens_on_Produce/file/79e4150d21b0226abf.pdf#page=187; Article by Nicoletti et al., “Shelf-life of a 2.5% sodium hypochlorite solution as determined by arrhenius equation”, Braz. Dent. J. vol. 20 no. 1 Ribeirão Preto 2009, http://dx.doi.org/10.1590/S0103-64402009000100004; Article by Fenner, et al., “The Anti-microbial Activity of Electrolysed Oxidizing Water Against Microorganisms Relevant in Veterinary Medicine,” Journal of Veterinary Medicine, Series B 53.3 (2006): 133-137; http://www.hyclo.com/articles/vet.pdf; Article by Christensen, “Gf and An Overview of Oxcide™: The Definitive Solution to Disinfection in Facility Water Distribution Systems & Equipment”, February 2003, http://www.essebilegionella.com/mediapool/106/1067992/data/Disinfectionof_Facility_H2O.pdf; Article by Izumi, “Electrolyzed Water as a Disinfectant for Fresh-Cut Vegetables,” Journal of Food Science 64.3 (1999): 536-539. http://www.hyclo.com/articles/veg.pdf; Article by Kumar, et al., “Efficacy of Electrolyzed Oxidizing Water for Inactivating Escherichia Coli O157: H7, Salmonella Enteritidis, and Listeria Monocytogenes,” Applied and Environmental Microbiology 65.9 (1999): 4276-4279 http://www.ncbi.nlm.nih.gov/pmc/articles/PMC99778/; Article by Falk, “The Chlorine/Cyanuric Acid Relationship and Implications for Nitrogen Trichloride,” http://standards.nsf.org/apps/group_public/download.php/5891/downloaded Sep. 11, 2013; and Article “Salt Chlorination,” http://www.che.cemr.wvu.edu/publications/projects/prod_design/salt_chlorination.pdf, downloaded Sep. 11, 2013.

These references are discussed in greater detail as follows.

U.S. Pat. No. 7,517,568 generally discloses packaging for dilute hypochlorite and hypochlorous acid compositions to produce stable compositions. Examples of suitable packaging containers are a bag-in-can device, a plastic aerosol container, a dual delivery container, a dual chambered device, an expandable chamber device, a precompression trigger sprayer, a mechanically pressurized device, and an ultrasonic sprayer.

U.S. Pat. No. 7,323,118 generally discloses a composition of hypochlorous acid having the following chemical composition: hypochlorous acid 6.5 to 7.3%, hydrochloric acid 27.6 to 28.5%, sodium chloride 13.6 to 14.2%, sodium hypochlorite 34.8 to 35.4%, chlorine in solution 6.57%, and dissolved oxygen 8.1 to 10.5%. The composition of hypochlorous acid has medical application in humans and in veterinary practice, both prophylactic and therapeutic. It can also be applied in antisepsis and sterilization of foods and in the treatment of water and water supply systems. In flower growing, it can be used for the disinfection of crops and the elimination of fusarium and sigatoka negra.

U.S. Pat. No. 7,276,255 generally discloses super-oxidized water based on hypochlorous acid, such as is obtained by the electrochemical treatment of a saline solution, which may be used in the treatment of leg ulcers or other open wounds. Preferably, the pH of the super-oxidized water is in the range of 4 to 7, and the water has a redox potential of >950 mV. Medicaments based on the super-oxidized water may be in liquid or gel form. The super-oxidized water is able to control the microbial population within the wound and at the same time permit cell proliferation.

U.S. Pat. No. 5,322,677 generally discloses a process for producing an aqueous hypochlorous acid solution effected by reacting droplets of an alkali metal hydroxide solution containing greater than 50 percent by weight of the alkali metal hydroxide with chlorine gas. The reaction produces a gaseous mixture of dichlorine monoxide, chlorine, hypochlorous acid vapor and water vapor, and solid particles of alkali metal chloride. The gaseous mixture is condensed at a temperature in the range of from about −33° C. to about −5° C. to produce the aqueous hypochlorous acid solution. The aqueous hypochlorous acid solutions produced are highly pure and as a result have significantly improved stability.

U.S. Pat. No. 5,108,560 generally discloses a process for producing chloric acid in an electrolytic cell having an anode and a cathode which includes feeding an aqueous solution of hypochlorous acid to the electrolytic cell, and electrolyzing the aqueous solution of hypochlorous solution to produce a chloric acid solution. Using the process of the invention, chloric acid can be produced efficiently at substantially reduced production costs using a process which can be operated commercially. In addition, the chloric acid solutions produced are of high purity and are stable at ambient conditions.

U.S. Pat. No. 4,190,638 generally discloses a continuous process for preparing hypochlorous acid comprising the steps of: (a) contacting cathode cell liquor with carbon dioxide containing gas to produce a wet, hydrated sodium carbonate-sodium bicarbonate precipitate; (b) feeding the wet precipitate to a fluid bed reactor and contacting the precipitate with a countercurrent flow of a mixture of gaseous chlorine and water vapor at a rate sufficient to maintain the bed of precipitate in a fluidized condition, where the molar ratio of water vapor to chlorine gas in the mixture fed to the fluid bed reactor is from about 0.5:1 to 0.9:1; (c) recycling a portion of precipitate that had been dried by contact with the gaseous mixture and mixing said portion with wet precipitate being fed to the fluid bed reactor; and (d) absorbing the gaseous effluent from the fluid bed reactor in water.

U.S. Pat. No. 4,065,545 generally discloses generally discloses an aqueous hypochlorite solution containing a stabilizing amount of periodate ions, preferably an amount in the range 0.05 to 1000 parts per million (ppm) by weight based on the volume of the solution, the solution optionally containing silicate ions.

U.S. Pat. No. 2,111,194 generally discloses a process of producing stable hypochlorous acid. The process consists in the combination in any aqueous solution of lime and an acid, in quantity sufficient to produce a precipitate which is substantially not soluble in the aqueous solution. While the precipitate is in suspension, chlorine is injected into the solution, until the required quantity of chlorine has been absorbed, after which the precipitate is permitted to settle, and the clear chlorinated liquid is filtered or drawn off, containing the stable hypochlorous acid in solution.

U.S. Pat. No. 1,732,230 generally discloses a method of producing stable water soluble compounds yielding hypochlorous acid when in contact with water, by mixing dry material containing the —OCl group with a dry material capable of dissociating in water with the formation of an acid, and compressing the resulting product in tablet form.

U.S. Patent Application Publication No. 2013/0216628 generally discloses compositions of hypochlorous acid (HOCl) and methods of manufacture thereof. The disclosure provides air-free compositions of HOCl.

The disclosed methods of making HOCl involve mixing together in water in an air-free environment, a compound that generates a proton (H′) in water and a compound that generates a hypochlorite anion (OCl—) in water to thereby produce air-free hypochlorous acid.

U.S. Patent Application Publication No. 2013/0146472 generally discloses a method utilizing cylindrical electrolysis cells for the generation of hypochlorous acid (HOCl) solutions having excellent sanitizing properties and a shelf life of 24 months when bottled. The electrolysis cells consist of at least two cylindrical electrodes with at least one cylindrical ion-selective membrane arranged co-axially between them. A cation-selective or anion-selective membrane separates the cathode chamber from the anode chamber allowing only selective ions to move from one chamber to another. A three-section end piece facilitates the assembly of the cylindrical electrolysis cell and enables easy inspection and replacement of the ion-selective membranes. The method allows production of different concentrations of hypochlorous acid solutions with a pH value ranging from 3.5 to 7.5 and a redox oxidation potential between +700 and +1200 mV when an aqueous sodium chloride or potassium chloride solution is treated.

U.S. Patent Application Publication No. 2012/0269904 generally discloses low pH antimicrobial solutions comprising hypochlorous acid, water, and optionally, a buffer. The low pH antimicrobial solutions have a pH from about 4 to about 6 and are useful for treating impaired or damaged tissue and for disinfecting surfaces. Chemical processes for the production of the low pH antimicrobial solutions are also disclosed wherein chlorine gas is added to a buffer solution containing a buffering agent and water. Also disclosed is an electrochemical process for the production of the low pH antimicrobial solutions.

U.S. Patent Application Publication No. 2012/0267256 generally discloses an apparatus for the selective production of electrolyzed water wherein the apparatus allows for the production of and discharge of either electrolyzed acidic water or electrolyzed basic water without the corresponding production and discharge of the other. In certain embodiments, the disclosure can provide a low chloride electrolyzed acidic water or a low chloride electrolyzed basic water.

U.S. Patent Application Publication No. 2012/0237616) generally discloses a stabilized hypohalous acid solution (or formulation thereof), which maybe conveniently packaged for sale, or stored for later use on demand. The disclosure further provides methods of making the stabilized hypohalous acid solution, as well as methods of use for disinfecting mammalian tissue, including wounds and burns, disinfecting or cleansing surfaces, or treating and/or preserving food products and cut flowers, among other uses.

U.S. Patent Application Publication No. 2012/0073983 A1 generally discloses an apparatus and a method of producing hypochlorous acid water suitable for sterilization. The producing apparatus includes an electrolytic vessel to which dilute hydrochloric acid is supplied and in which no diaphragm exists between an anode and a cathode for generating a chlorine gas, a storage tank in which water is stored, a circulation pipe into which water flows from the storage tank, in which the water circulates, and from which the water returns into the storage tank, and a mixing pipe which couples between the electrolytic vessel and the circulation pipe, mixing the chlorine gas from the electrolytic vessel with the water in the circulation pipe, and thus producing hypochlorous acid water.

U.S. Patent Application Publication No. 2011/0256243 generally discloses a system to prepare an antimicrobial solution by the electrolysis of brine. The antimicrobial solution comprises a 100 ppm or more HOCl solution at a pH of approximately 6.5. The system includes an electrolysis cell that is provided with a constant current by a digital DC power supply controlled by a microprocessor and a controlled brine concentration at a controlled rate, which can also be controlled by the microprocessor to deliver a fluid that is continuously observed by a pH probe and an ORP probe that provides input to the microprocessor to adjust voltage, pump rate and/or flow rate in a programmed manner by the microprocessor. A method to produce the antimicrobial solution, including a sporicidal solution, by the disclosed system is presented.

U.S. Patent Application Publication No. 2010/0310672 generally discloses a disinfectant based on an aqueous, hypochlorous acid-containing solution, especially in the form of an electrochemically activated, diluted water/electrolyte solution, as well as method for producing such a disinfectant also in case the disinfectant has a large surface, e.g. when the disinfectant is applied to surfaces. The disinfectant further contains a certain percentage of amorphous silica (SiO2), particularly in the form of amorphous silicic acids and/or amorphous silicic anhydrides. The SiO2 percentage can be selected in such a way as to increase the viscosity of the aqueous solutions to the point where the solution gels. The invention further relates to the use of such a disinfectant.

U.S. Patent Application Publication No. 2009/0081077 generally discloses an electrolyzed alkaline water production unit and an electrolyzed alkaline water production method resulting in improved storage stability before use and improved safety in comparison with strong alkaline solutions. The electrolyzed alkaline water thus produced has a pH value of at least 10 or more. The electrolysis cell may have a diaphragm or, optionally, it may not.

U.S. Patent Application Publication No. 2005/0232847 generally discloses methods of diluting hypochlorite and hypochlorous acid compositions to produce stable compositions. These compositions can be used to treat allergen containing surfaces, hard surfaces, food contact surfaces, hospital surfaces, food surfaces, kitchen surfaces, bathroom surfaces, human surfaces, animal surfaces, military equipment, transportation equipment, children's items, plant surfaces, seeds, outdoor surfaces, soft surfaces, air, wounds, and medical instruments.

WIPO Patent Application Publication No. WO 2013/134327 A1 generally discloses a disinfectant solution, comprising an oxidative and reductive potential (ORP) solution and a colorant. The colorant is dissolved in the ORP solution and renders the disinfectant solution a visible color. The colorant comprises potassium permanganate and is added in a concentration between about 1 ppm and about 10%. The pH value of the disinfectant solution is between about 3 and about 9. The potential of disinfectant solution is between +500 mV and +1250 mV. In certain embodiments, the ORP solution contains at least one species having disinfectant ability. The species is chlorine, bromine or ozone. The chlorine is free available chlorine and the concentration of the free available chlorine is about 5 ppm to about 6%.

WIPO Patent Application Publication No. WO 2012/123695 generally discloses a stable antimicrobial aqueous hypochlorous acid solution that retains its activity for at least three months and can be provided with high levels of hypochlorous acid (more than 500 ppm). The aqueous hypochlorous acid composition has low chloride concentrations (maximum chloride levels of 1:3 chloride to hypochlorous acid) and a pH between 3.5 and 7.0, to stabilize the composition without the need for additional stabilizers. A solid composition is also provided for producing the stable solution.

WIPO Patent Application Publication No. WO 2012/041357 generally discloses a method for producing a disinfectant containing hypochlorous acid (HOCl) and/or hypochlorite (—OCl) by electrochemical activation of a dilute water/chloride solution, in that water is added to a chloride solution and the dilute water/chloride solution is exposed to an electric current in the anode chamber of an electrolysis reactor which comprises at least one cathode chamber having a cathode and at least one anode chamber, which is spatially separated therefrom by a membrane, and comprises an anode, by applying an electric voltage to the electrodes, in order to convert the chloride at least in part to hypochlorous acid and/or hypochlorite. In order to decrease the consumption of chloride, the disclosure provides that the water/chloride solution is only delivered to the anode chamber of the electrolysis reactor, whereas the cathode chamber of the electrolysis reactor is fed with water which has not been admixed with chloride ions.

European Patent Application Publication No. EP 2 277 827 A2 generally discloses a method for preparing a stabilized antimicrobial hypochlorous acid solution by diluting an aged stock solution to provide a hypochlorous acid solution at a concentration of about 50 to about 7000 ppm at a pH range of about 2.8 to about 4.0. The antimicrobial hypochlorous acid solution maintains at least 75 percent of the available chlorine present over a period of about 6 months to about 12 months. The antimicrobial hypochlorous acid solution has medical applications in humans and veterinary practice, both prophylactic and therapeutic. The solution can also be used for non-medical applications in antisepsis and sterilization of surfaces. The method of preparing the composition of an antimicrobial hypochlorous acid solution comprises the steps of: combining about 18 to 22 percent of a first solution containing about 13 percent sodium hypochlorite with 1.0 to 1.4 percent of a second solution containing about 33 percent hydrochloric acid, and combining the mixture of the first and second solutions with about 86 percent water. The resulting solution contains 2 to 3 percent sodium hypochlorite. This 2 to 3 percent sodium hypochlorite solution is further mixed with the second solution (33 percent hydrochloric acid) to form a stock solution containing about 0.3 to 0.5 percent hydrogen chloride. This stock solution has a pH of about 4 to 6 and an oxidation reduction potential of about 850 to 1450 mV. This solution is maintained at ambient temperature in a sealed container in the substantial absence of light for about 18 to 30 hours to form an aged stock solution. The disclosed antimicrobial hypochlorous acid solution is formed by diluting the aged stock solution to about 50 to 7000 ppm hypochlorous acid and adjusting the pH to about 2.8 to 4.0. This antimicrobial hypochlorous acid solution, when sealed and in the dark at a temperature of about 18° C. to about 22° C., maintains at least about 75 percent of the available chlorine present over a period of about 6 months to about 12 months.

WIPO Patent Application Publication No. WO 2010/025276 generally discloses containers and dispensers for delivery of a variety of compositions, as well as devices for nasal delivery of the compositions. The compositions may be useful in preventing, treating and/or reducing the risk of an infection in a subject in need thereof. In certain embodiments the composition comprises oxidized water, sodium hypochlorite (NaOCl), hypochlorous acid (HOCl) and sodium chloride (NaCl).

WIPO Patent Application Publication No. WO 2007/070637 generally discloses methods for treating open wounds, such as chronic refractory open wound, by administering an electrolyzed saline solution comprising hypochlorous acid. A method of alleviating the pain associated with open wounds by administering an electrolyzed saline solution is also disclosed. Combination treatment methods are also disclosed where an electrolyzed saline solution is administered subsequent to or concurrently with standard compression bandaging.

European Patent Application Publication No. EP 1 721 868 Al generally discloses single-part additive solution for use in the production of electrolyzed hypochlorous acid-containing sterilizing water prepared by mixing and dissolving, in advance, HCl and NaCl in a predetermined amount of water.

In the book “AQUEOUS ANTIMICROBIAL TREATMENTS TO IMPROVE FRESH AND FRESH-CUT PRODUCE SAFETY,” by Herdt et al; in Microbial Safety of Fresh Produce (2009): 169; http://www.researchgate.net/publication/-228014922_Biological_Control_of_Human_Pathogens_on_Produce/file/79e4150d21b0226abf.pdf#page=187; hypochlorous acid as an antimicrobial treatment for produce is generally disclosed. A typical concentration of chlorine in such a sanitation treatment is 200 mg/L (approx. 200 ppm) at pH less than 8.0 and a contact time of 1-2 minutes for raw vegetables and fruits.

In the article by Nicoletti et al., “Shelf-life of a 2.5% Sodium Hypochlorite Solution as Determined by Arrhenius Equation”, BRAZ. DENT. J. vol. 20 no. 1 Ribeirão Preto 2009, http://dx.doi.orq/10.1590/S0103-64402009000100004, accelerated stability testing of chemical degradation is generally discussed. The method is based on increased stress conditions to accelerate the rate of chemical degradation. Based on the equation of the straight line obtained as a function of the reaction order at 50 and 70° C. and using the Arrhenius equation, the speed of the reaction is calculated for the temperature of 20° C. (normal storage conditions). As an example of the applicability of the Arrhenius equation in accelerated stability tests, a 2.5% sodium hypochlorite solution was analyzed. Based on data obtained by keeping this solution at 50 and 70° C., and considering 2% free residual chlorine as the minimum acceptable threshold, the shelf life at 20° C. was calculated to be 166 days.

In an article by Fenner, et al., “The Anti-microbial Activity of Electrolysed Oxidizing Water against Microorganisms relevant in Veterinary Medicine,” JOURNAL OF VETERINARY MEDICINE, Series B 53.3 (2006): 133-137; http://www.hyclo.com/articles/vet.pdf; the anti-microbial efficacy of anode-side electrolyzed oxidizing water against various microbes is discussed.

In an article by Christensen, “G_{f} and An Overview of Oxcide™: The Definitive Solution to Disinfection in Facility Water Distribution Systems & Equipment”, February 2003, http://www.essebi-legionella.com/mediapool/-106/1067992/data/Disinfection_of_Facility_H2O.pdf; the advantages of hypochlorous acid as a disinfectant in water distribution systems and equipment, compared to other typical methods of water disinfection, is discussed.

In an Article by Izumi, “Electrolyzed Water as a Disinfectant for Fresh-Cut Vegetables,” JOURNAL OF FOOD SCIENCE 64.3 (1999): 536-539 http://www.hyclo.com/articles/veg.pdf; the effect of electrolyzed water on total microbial count on fresh-cut vegetables is discussed. When fresh-cut carrots, bell peppers, spinach, Japanese radish and potatoes were treated with electrolyzed water (pH 6.6, 20 ppm available chlorine) by dipping, rinsing or dipping/blowing, microbes on all cut surfaces were reduced by 0.6 to 2.6 logs colony forming units per gram. Electrolyzed water containing 50 ppm available chlorine had a stronger bactericidal effect than electrolyzed water containing 15 or 30 ppm available chlorine for fresh-cut carrots, spinach or cucumber. Electrolyzed water did not affect tissue pH, surface color or general appearance of fresh-cut vegetables.

In an article by Kumar, et al., “Efficacy of Electrolyzed Oxidizing Water for Inactivating Escherichia Coli O157: H7, Salmonella Enteritidis, and Listeria Monocytogenes,” APPLIED AND ENVIRONMENTAL MICROBIOLOGY 65.9 (1999): 4276-4279, http://www.ncbi.nlm.nih.gov/pmc/articles/PMC99778/the efficacy of electrolyzed oxidizing water for inactivating Escherichia coli O157:H7, Salmonella enteritidis, and Listeria monocytogenes is discussed. A five-strain mixture of E. coli O157:H7, S. enteritidis, or L. monocytogenes of approximately 10 colony forming units per milliliter was inoculated in 9 milliliters of electrolyzed oxidizing water (treatment) or 9 milliliters of sterile, deionized water (control) and incubated at 4 or 23° C. for 0, 5, 10, and 15 minutes; at 35° C. for 0, 2, 4, and 6 minutes; or at 45° C. for 0, 1, 3, and 5 minutes. The surviving population of each pathogen at each sampling time was determined on tryptic soy agar. At 4 or 23° C., an exposure time of 5 minutes reduced the populations of all three pathogens in the treatment samples by approximately 7 log colony forming units per milliliter, with complete inactivation by 10 min of exposure. A reduction of ≧7 log colony forming units per milliliter in the levels of the three pathogens occurred in the treatment samples incubated for 1 min at 45° C. or for 2 min at 35° C. The bacterial counts of all three pathogens in the control samples remained the same throughout the incubation at all four temperatures. Results indicated that electrolyzed oxidizing water may be a useful disinfectant, but appropriate applications need to be validated.

In an article by Falk, “The Chlorine/Cyanuric Acid Relationship and Implications for Nitrogen Trichloride,” http://standards.nsf.oro/apps/-group_public/download.php/5891/, downloaded Sep. 11, 2013, the amount of hypochlorous acid (HOCl) in water with cyanuric acid added at typical pool pH is proportional to the free chlorine/cyanuric acid ratio and is orders of magnitude lower than the free chlorine level itself was discussed.

The primary oxidizing and sanitizing compound is hypochlorous acid while hypochlorite ion and the chlorinated isocyanurate compounds (chlorine attached to cyanuric acid) have orders of magnitude lower oxidizing or sanitizing capability.

In an article entitled, “Salt Chlorination,” http://www.che.cemr.wvu.-edu/oublications/-projects/prod_design/salt_chlorination.pdf, downloaded Sep. 11, 2013, efforts to optimize the temperature, number of plates in the electrolytic cell, and the plate spacing used to electrolytically produce hypochlorous acid for disinfecting residential and commercial swimming pools are discussed.

In an assessment of the foregoing efforts to implement uses and testing of hypochlorous acid, problems associated with the foregoing can be discerned, as illustrated by just a few examples.

A problem associated with efforts that precede the instant disclosure is that they fail to provide, in combination with the other features and advantages disclosed herein, a method of producing hypochlorous acid that results in extended shelf life of hypochlorous acid to 24 months.

Another problem associated with efforts that precede the instant disclosure is that they fail to provide, in combination with the other features and advantages disclosed herein, a storage container which maintains the efficacy of the hypochlorous acid for 24 months.

Still a further problem associated with efforts that precede the instant disclosure is that they fail to provide, in combination with the other features and advantages disclosed herein, an improved shelf life hypochlorous acid solution suitable for use as a food contact sanitizer.

An even further problem associated with efforts that precede the instant disclosure is that they fail to provide, in combination with the other features and advantages disclosed herein, an improved shelf life hypochlorous acid solution suitable for use as a non-food contact sanitizer.

Yet a further problem associated with efforts that precede the instant disclosure is that they fail to provide, in combination with the other features and advantages disclosed herein, an improved shelf life hypochlorous acid solution suitable for use as streak free cleaner.

A still further problem associated with efforts that precede the instant disclosure is that they fail to provide, in combination with the other features and advantages disclosed herein, an improved shelf life hypochlorous acid solution suitable for use as a cut flower life extender.

There is a demand, therefore, to overcome the foregoing problems while at the same time providing an improved shelf life hypochlorous acid solution that is adaptable to a multiplicity of uses and that is also relatively low in cost to manufacture and yet possesses an extended shelf life.

### SUMMARY OF THE DISCLOSURE

It is an object of the present disclosure is to provide, in combination with the other features and advantages disclosed herein, a method of producing and storing hypochlorous acid resulting in the improvement of shelf life of the hypochlorous acid to 24 months.

An additional object of the present disclosure is to provide, in combination with the other features and advantages disclosed herein, a storage container which maintains the efficacy of the hypochlorous acid for 24 months.

A still further object of the disclosure is to provide, in combination with the other features and advantages disclosed herein, an improved shelf life hypochlorous acid solution suitable for use as a food contact sanitizer.

Another object of the disclosure is to provide, in combination with the other features and advantages disclosed herein, an improved shelf life hypochlorous acid solution suitable for use as a non-food contact sanitizer.

Yet another object of the disclosure is to provide, in combination with the other features and advantages disclosed herein, an improved shelf life hypochlorous acid solution suitable for use as streak free cleaner.

A yet still further object of the disclosure is to provide, in combination with the other features and advantages disclosed herein, an improved shelf life hypochlorous acid solution suitable for use as a cut flower life extender.

In a preferred embodiment, tap water is treated by being processed through a water softener and then a reverse osmosis system. The treated water is then combined with a saturated solution (made using the softened and purified tap water) of high purity sodium chloride to form a saline process solution.

The saline process solution is then electrolyzed by being passed through a chamber with an anode (positive electrode) on one side and a cathode (negative electrode) on the other side. The anode and cathode are separated by a membrane that only permits the migration of chemical ions, in one direction, from one electrode to other. The membrane may be a bipolar membrane or a cation exchange membrane comprised of a sulfonated tetrafluoroethylene based fluoropolymer-copolymer (Nafion).

The saline molecules are split by the electrical charge, forming hypochlorous acid on the anode side and sodium hydroxide on the cathode side. The two chemical streams are then collected in separate storage tanks and pumped to the bottling equipment and injected into plastic bottles of varying types for distribution.

The electrolysis process equipment can be set to varying applied amperages as well as pH of hypochlorous acid solution. The water softening step is a standard ion exchange system that exchanges undesirable Ca and Mg ions for Na ions. The reverse osmosis system removes organics and dissolved solids in the tap water.

In a preferred embodiment, the electrolysis system equipment is set to pH range 3.0-7.5. In a more preferred embodiment, the electrolysis system equipment is set to pH range 3.5-6.0. In a still more preferred embodiment, the electrolysis system is set to 5.0 pH acid output.

The following disclosure provides processes for producing and storing hypochlorous acid that provides the foregoing advantages while at the same time provides an extended shelf life hypochlorous acid that mitigates the need to make hypochlorous acid on-site. Further, the disclosure provides storage methods for the extended shelf life hypochlorous acid. The disclosure also provides the use of the extended shelf life hypochlorous acid as a hospital disinfectant and as a sanitizer for food contact and non-food contact surfaces. The disclosure provides the use of the extended shelf life hypochlorous acid as a cleaner and deodorizer. The disclosure further provides the use of the extended shelf life hypochlorous acid as a cut flower life extender.

### BRIEF DESCRIPTION OF THE DRAWINGS

In the detailed description that follows, reference will be made to the following figures:

FIG. 1 is a schematic illustration of a first embodiment production scheme of improved shelf life hypochlorous acid;

FIG. 2 illustrates the available chlorine present as hypochlorous acid as a function of pH;

FIG. 3 is a plot of the change over time of FAC of various hypochlorous acid solutions stored in various bottle materials;

FIG. 4 is a plot of the change over time of FAC of various hypochlorous acid solutions stored in various container materials;

FIG. 5 is a photograph of a cut flower stored in hypochlorous acid solution for 30 days;

FIG. 6 is a plot of the change over time of FAC of two solutions of hypochlorous acid stored in white opaque PET bottles at 45° C.; and

FIG. 7 is a schematic illustration of a second embodiment production scheme of improved shelf life hypochlorous acid.

### DETAILED DESCRIPTION OF PREFERRED EMBODIMENTS

The preferred embodiments will be described in a series of examples showing production details and the improvement in shelf life effected with various materials used for storage bottles. Example 1 details a first embodiment production scheme for extended life hypochlorous acid. Examples 2-9 will illustrate the uses of the extended-life hypochlorous acid made according to the first embodiment production scheme. One example details using the extended life hypochlorous acid as a household sanitizer or disinfectant. Another example shows the use of the improved shelf life hypochlorous acid as an improved glass cleaner. The next series of examples details the use of the improved shelf-life hypochlorous acid as a life extender solution for cut flowers.

Examples 10 and 11 show accelerated aging of extended shelf life hypochlorous acid made according to the first embodiment production scheme in various containers and the effect of container material on the shelf life of extended shelf life hypochlorous acid. Example 12 details a second embodiment production scheme for extended shelf life hypochlorous acid.

It is understood that the uses of extended shelf life hypochlorous acid detailed in the examples apply to either of the production scheme embodiments (Example 1 or Example 12) of extended shelf life hypochlorous acid described. It is also understood that the effect of the container on shelf life of the extended shelf life hypochlorous acid can be applied to hypochlorous acid made according either of the production scheme embodiments described.

### Example 1

### First Embodiment Production Scheme of Extended Life Hypochlorous Acid

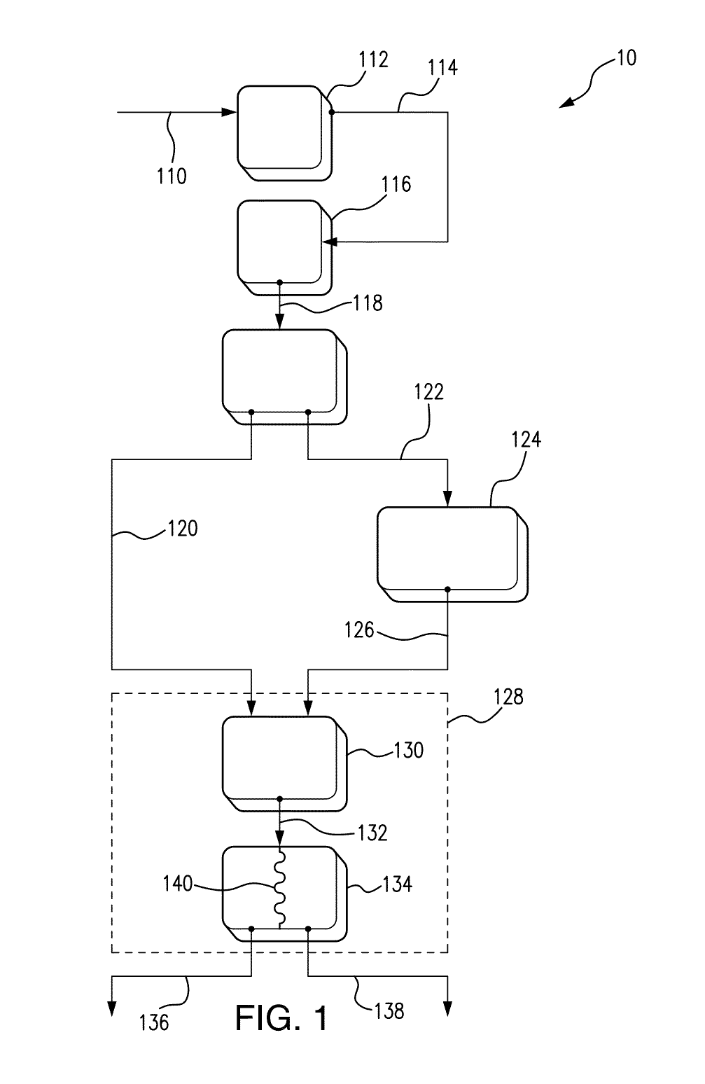

FIG. 1 shows a process flow diagram for a first embodiment production system 10 for improved shelf life hypochlorous acid. In the production system 10, tap water 110 flows to the water softener system 112 (General Electric Model GXSH40V 00) where calcium (Ca) and magnesium (Mg) ions are removed. A softened water stream 114 emerges from the water softener 112 and enters a reverse osmosis system (US water Systems Model APRO 5050P) 116. Softened, purified water 118 flows from the reverse osmosis system 116 and is separated into a first stream 120 and a second stream 122. Second stream 122 is combined with 99.9% pure food grade salt 124 (Morton Culinox 999) and emerges as a 26% saturated salt solution 126. While pure food grade salt was used, it is anticipated that favorable results would be achieved using salt having purity of about 99% or greater. The first stream 120 of purified water and the 26% saturated salt solution 126 enter an electrolysis system 128 (EAU Technologies P38HDSS88T).

The electrolysis system 128 comprises a mixing stage 130, and an electrolysis stage 134.

The mixing stage 130 combines the streams 120 and 126 into a diluted salt solution 132. The mixing stage 130 is constructed and arranged to be able to produce varying concentrations of the diluted salt solution 132. The diluted salt solution 132 then flows to the electrolysis stage 134 to produce a hypochlorous acid solution stream 136 and a sodium hydroxide solution 138.

The electrolysis stage 134 is constructed and arranged to be able to produce varying concentrations and pH of the hypochlorous acid solution 136 and sodium hydroxide solution 138. The electrolysis stage 134 utilizes a bipolar membrane 140 in the production of the hypochlorous acid solution 136 and the sodium hydroxide solution 138.

The hypochlorous acid solution 136 is bottled. The hypochlorous acid solution 136 and sodium hydroxide solution 138 are less than 110° F. when they emerge from the electrolysis system 128. This production scheme can produce up to 30 gallons per hour of hypochlorous acid solution and 8 gallons per hour of sodium hydroxide solution.

Table 1 shows an analysis of the tap water stream 110 prior to and after the water softening and reverse osmosis steps. It is anticipated that favorable results would be achieved after processing the water to have hardness of <40 ppm and alkalinity <40 ppm, with total dissolved solids <80 ppm.

TABLE 1
Effect of water softening and reverse osmosis on water purity

| | Prior to softening and | After softening and |
|---|---|---|
| | reverse osmosis | reverse osmosis |
| | Parts per million (ppm) | Parts per million (ppm) |
| Impurity | impurity | impurity |
| Hardness | 360 | <20 |
| Alkalinity | 320 | <20 |
| Total Dissolved Solids | 580 | <50 |

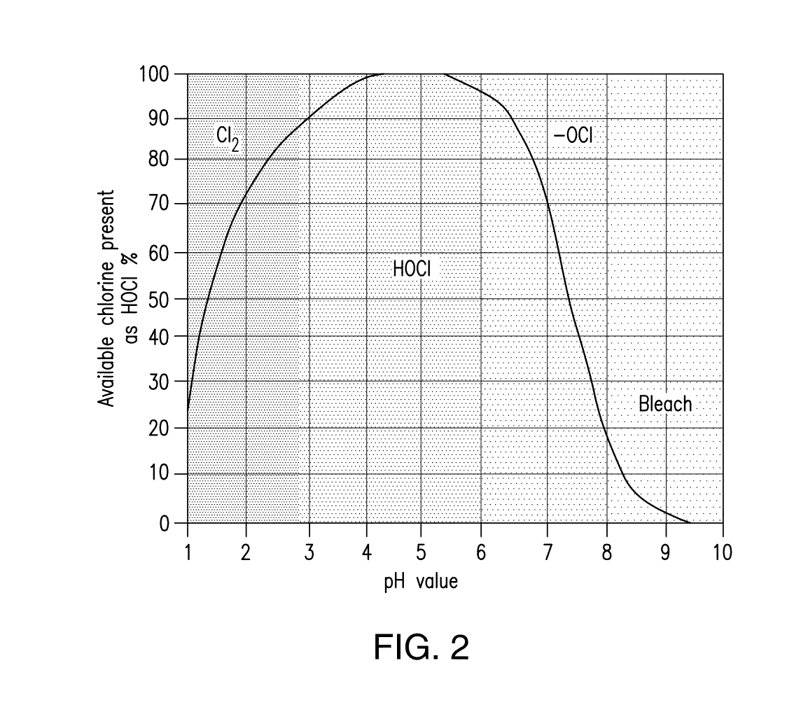

The concentration of hypochlorous acid solutions (HOCl) are usually reported as free available chlorine (FAC) in parts per million (ppm). Hypochlorous acid (HOCl) is in equilibrium with hypochlorite ion (⁻OCl) and Cl₂ and the extent of the equilibrium is controlled by the pH of the solution, as shown in FIG. 2. Therefore, both FAC and pH need to be known to understand the amount of chlorine present as hypochlorous acid.

As shown in FIG. 2, in the pH range of 4 to 5.6, approximately 100% of the available chlorine is present as HOCl. Thus at pH 5, a 100 ppm FAC solution will have 100 ppm chlorine present as HOCl.

However, at a pH of 3, about 90% of the available chlorine is present as hypochlorous acid. Thus, a 100 ppm FAC solution at pH 3 will have 90 ppm FAC present as HOCl.

At pH 7.5 only 50% of the FAC will be present as hypochlorous acid.

As described above, in the pH range of 4 to 5.6, almost all of the chlorine is present as HOCl. Because hypochlorous acid is less corrosive and a more effective sanitizer and disinfectant than the hypochlorite ion, the pH range 4 to 5.6 is preferred.

The electrolysis system 128 may be adjusted for amperes of direct current electricity supplied to the salt solution 132 and desired pH of hypochlorous acid solution 136. These control the FAC and pH of the resulting hypochlorous acid stream 136.

FAC in ppm is considered a measure of the sanitizing and disinfecting properties of the hypochlorous acid solution.

Oxidation-Reduction Potential (ORP) in millivolts (mv) is also considered a measure of the sanitizing and disinfecting properties of the hypochlorous acid solution. The bactericidal effect of hypochlorous acid solution against various strains of bacteria is due to the combined action of oxidation-reduction reactions of the hypochlorous acid and the FAC of the hypochlorous acid. Oxidation-reduction reactions at the cell membrane damage the outer and inner cell membrane and inactivate the defense mechanism of bacteria. After the oxidation-reduction reactions destroy the cell membrane, hypochlorous acid can easily penetrate the cells and destroy the microorganisms from inside. ORP depends on pH and concentration (ppm FAC) of hypochlorous acid. Lower pH and high ppm FAC solutions will have higher ORP because HOCl is a better oxidizer than the hypochlorite ion.

Table 2 shows typical process conditions and resulting FAC and ORP of the hypochlorous acid stream 136.

TABLE 2
Typical production process conditions
Up to 38 gallons per hour (total of HOCl and NaOH) or
Up to 30 gallons per hour HOCl.

| | | | | Temperature of |
|---|---|---|---|---|
| | pH | FAC | | output stream, |
| Amps DC | set point | (ppm) | ORP (mv) | ° F. |
| 52 | 5.0 | 196 | 1033 | 74 |
| 52 | 3.5 | 195 | 1116 | 74 |
| 52 | 6.0 | 195 | 844 | 73 |
| 40 | 4.5 | 146 | 927 | 73 |
| 40 | 5.0 | 144 | 901 | 73 |
| 35 | 3.5 | 116 | 1063 | 72 |
| 35 | 3.8 | 110 | 951 | 72 |
| 35 | 5.0 | 107 | 838 | 72 |
| 30 | 5.0 | 72.5 | 839 | 74 |
| 65 | 6.0 | 242 | 895 | 75 |
| 75 | 6.0 | 349 | 927 | 75 |
| 25 | 5.0 | 98 | 764 | 72 |
| 98 | 5.0 | 505 | 1079 | 72 |

Examples 2-11 use hypochlorous acid made according to the process set forth in Example 1.

### Example 2

### Effect of Container Material on Shelf Life of Hypochlorous Acid

Hypochlorous acid solutions at various initial pH levels were stored for 4 to 6 months in various plastic container materials at room temperature and the FAC levels were monitored over time. Each bottle was rinsed with the hypochlorous acid solution before being filled for storage.

The plastic materials tested are shown in Table 3.

TABLE 3
Tested Packaging materials

| Material | Package type |
|---|---|
| Natural high density polyethylene | 32 oz Bottle |
| (HDPE) | |
| White polyethylene terephthalate (PET) | 32 oz Bottle |
| CKS Packaging, Inc. Model 6063 | |
| Filled with 2-3% TiO₂ | |
| 0.015″ minimum wall thickness | |
| Amber PET | 32 oz Bottle |
| Ethylene vinyl alcohol copolymer | Bag in box |
| (EVOH) | |
| Polyamide and polyethylene | Bag in box |
| 3 layer laminate (Nylon/PE) | |
| Scholle product 20005 | |
| 28μ PE | |
| 15.2μ Biaxially oriented Nylon | |
| 63.5μ PE | |
| Polyamide and polyethylene | Bag in a box |
| 3 layer laminate (Nylon/PE) | |
| D.S. Plastics RaPak | |
| 25.4μ PE | |
| 15.2μ Nylon | |
| 50.8μ PE | |
| Low density polyethylene (LDPE) | Bag in box |

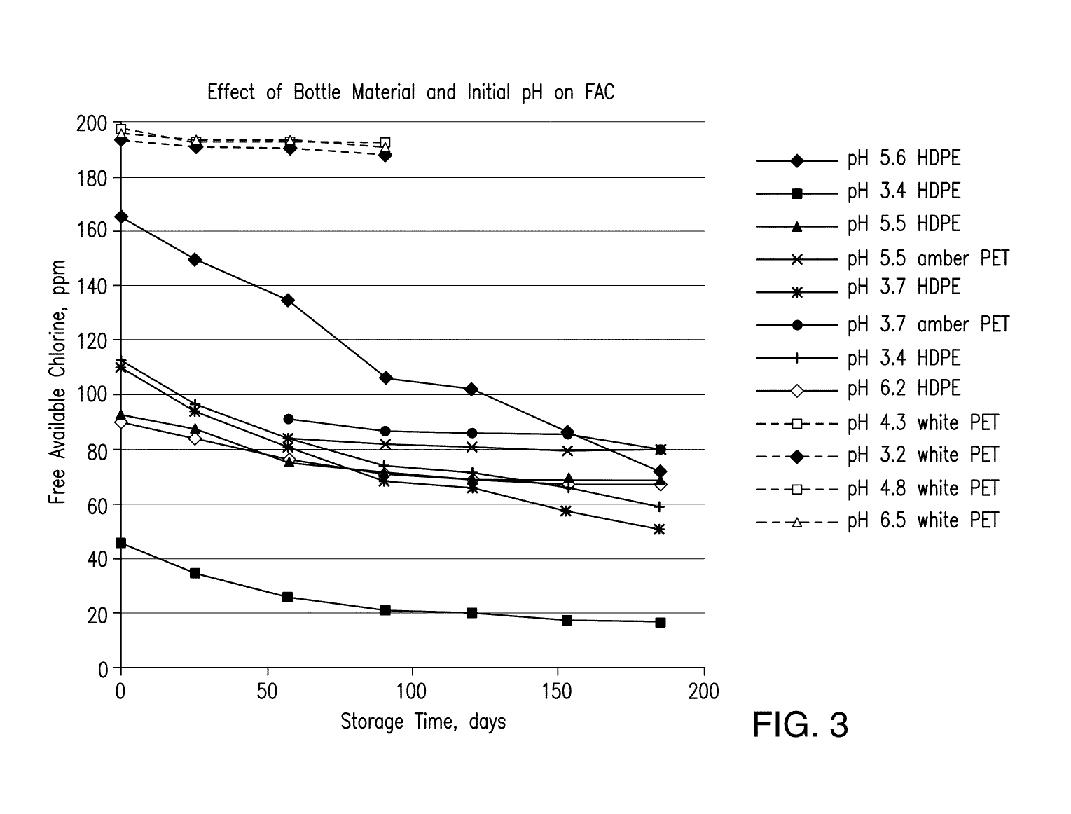

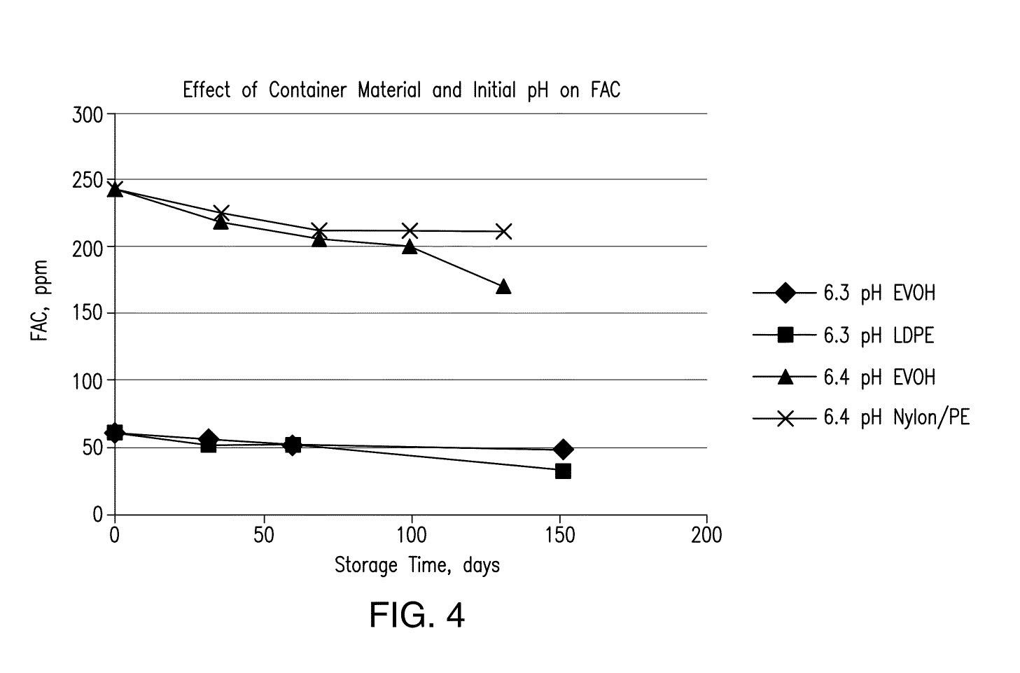

The results for hypochlorous acid solutions after storage are plotted in FIG. 3 for bottles and in FIG. 4 for the bags in a box.

As can be seen in FIG. 3, hypochlorous acid solutions stored in white PET bottles exhibited superior retention of FAC over time, compared to natural HDPE or amber PET bottles. After three months storage, the FAC of the hypochlorous acid solutions had dropped a maximum of 2.6%, while the FAC of the hypochlorous acid solutions in natural HDPE and amber PET had dropped 53% and 35%, respectively, after 3 months storage. The FAC of the hypochlorous acid solutions in the white opaque PET bottles did not drop between months 2 and 3 of storage.

FIG. 4 demonstrates that initial pH 6.4 hypochlorous acid solutions stored in a Nylon/PE bag in a box exhibited enhanced storage stability as measured by FAC compared to EVOH bag in a box. For 6.3 pH solutions, the EVOH bag exhibited better storage stability as measured by FAC compared to the LDPE bag. After 4 months storage, the FAC of hypochlorous acid solutions stored in the Nylon/PE bag had dropped only a maximum of 12.4% and more significantly, did not exhibit any drop between 2 months and 4 months of storage, while the FAC of the hypochlorous acid solution stored in EVOH had dropped off 28.9% for the 6.4 pH hypochlorous acid solution, and was continuing to fall for the same time period. The FAC of the 6.3 pH hypochlorous acid solution stored in the LDPE bag dropped 45.9% after 5 months.

### Example 3

### Effect of Sunlight Exposure on Storage of Hypochlorous Acid in High Density Polyethylene Bottle

A 3.5 pH solution of hypochlorous acid was made and stored in a high density polyethylene (HDPE) bottle outside, in full sunlight, for 15 days. The results, in terms of FAC and percent drop in FAC are shown in Table 4.

TABLE 4
Change in FAC of 3.5 pH hypochlorous acid exposed to sunlight
outside in HDPE bottle

| | | FAC | |
|---|---|---|---|
| Storage time (days) | Temperature (° F.) | (ppm) | % drop FAC |
| 0 | 71 | 112.5 | 0.0 |
| 3 | 70 | 106.5 | 5.3 |
| 4 | 42 | 99.5 | 11.6 |
| 5 | 41 | 104.0 | 7.6 |
| 6 | 50 | 102.5 | 8.9 |
| 6 | 64 | 100.0 | 11.1 |
| 7 | 39 | 99.0 | 12.0 |
| 10 | 45 | 100.0 | 11.1 |
| 12 | 38 | 79.0 | 29.8 |
| 17 | 45 | 61.0 | 45.8 |

At the temperatures tested, the 3.5 pH hypochlorous acid solution exhibited a 45% drop in FAC after 17 days, showing that the HDPE bottle was not a suitable storage container for hypochlorous acid exposed to sunlight.

### Example 4

### Effect of Cyanuric Acid on Storage of Hypochlorous Acid Solutions Exposed to Sunlight

Two different initial pH solution of hypochlorous acid were made. Each these solutions was treated with 0, 6 or 12 ppm cyanuric acid and then stored in HDPE bottles and exposed to sunlight for one month or 2 months at 69° F. The results are shown in Table 5 for initial pH 6.5 and in Table 6 for initial pH 5.8.

TABLE 5
Effect of cyanuric acid on pH 6.5 hypochlorous acid
solution exposed to sunlight in HDPE bottle

| | 0 ppm cyanuric | | 6 ppm cyanuric | | 12 ppm cyanuric | |
|---|---|---|---|---|---|---|
| Storage | acid | | acid | | acid | |
| time, | FAC | % drop | | % drop | | % drop |
| days | (ppm) | FAC | FAC | FAC | FAC | FAC |
| 0 | 119 | 0 | 119 | 0 | 119 | 0 |
| 60 | 80 | 32.8 | 45 | 62.7 | 14 | 88 |

TABLE 6
Effect of cyanuric acid on pH 5.8 hypochlorous acid
solution exposed to sunlight in HDPE bottle

| | 0 ppm cyanuric | | 6 ppm cyanuric | | 12 ppm cyanuric | |
|---|---|---|---|---|---|---|
| Storage | acid | | acid | | acid | |
| time, | FAC | % drop | | % drop | | % drop |
| days | (ppm) | FAC | FAC | FAC | FAC | FAC |
| 0 | 63 | 0 | 63 | 0 | 63 | 0 |
| 29 | 47 | 25.4 | 43 | 31.7 | 20 | 68.2 |

Higher levels of cyanuric acid and longer exposure to sunlight resulted in a greater drop in FAC level, showing that cyanuric acid did not preserve the FAC over time of hypochlorous acid solutions exposed to sunlight.

In order to improve the storage time of hypochlorous acid, the solutions should not have added cyanuric acid.

### Example 5

### Hypochlorous Acid as Sanitizer or Disinfectant

A 140 ppm FAC solution of hypochlorous acid stored for 53 days in a white opaque PET bottle was tested for non-food and food contact sanitizing. The results are shown in Table 7.

TABLE 7
Results of sanitizing tests on 140 ppm FAC hypochlorous acid
solution stored for 53 days in white opaque PET bottle

| Test | Test | | FAC | Test | EPA |
|---|---|---|---|---|---|
| reference | name | Organism | (ppm) | result | specification |
| ASTM | EPA | Staphylococcus | 140 | >99.999% | 99.9% |
| E 1153-03 | non-food | aureus | | reduction | reduction |
| | contact | | | (passed) | |
| | sanitizer | | | | |
| ASTM | EPA | Klebsiella | 140 | >99.999% | 99.9% |
| E 1153-03 | non-food | pneumoniae | | reduction | reduction |
| | contact | | | (passed) | |
| | sanitizer | | | | |
| AOAC | EPA | Salmonella | 140 | Test was | Equivalent |
| 955.16 | Food | typhi | | equivalent | to 50, 100, |
| | contact | | | to 200 | 200 ppm |
| | sanitizer | | | ppm | NaOCl |
| | | | | NaOCl | |
| | | | | (passed) | |

Three solutions of approximately 132 ppm FAC and approximate pH 5 were also tested for efficacy against various organisms for food and non-food contact surfaces. These solutions were stored for 33-69 days at room temperature in white opaque PET containers before testing. The results are shown in Table 8.

TABLE 8
Results of sanitizing tests for hypochlorous acid solutions stored in white PET bottles

| | | | | | Storage | | |
|---|---|---|---|---|---|---|---|
| Test | Test | | FAC | | time | | EPA |
| reference | name | Organism | (ppm) | pH | (days) | Test result | specification |
| AOAC | EPA | Salmonella | 133 | 4.89 | 69 | Equivalent | Equivalent to |
| 955.16 | Food | typhi | | | | to 200 ppm | 50, 100, 200 |
| | contact | | | | | NaOCl | ppm NaOCl |
| | sanitizer | | | | | (passed) | |
| AOAC | EPA | Salmonella | 132 | 4.86 | 68 | Equivalent | Equivalent to |
| 955.16 | Food | typhi | | | | to 200 ppm | 50, 100, 200 |
| | contact | | | | | NaOCl | ppm NaOCl |
| | sanitizer | | | | | (passed) | |
| AOAC | EPA | Salmonella | 132 | 5.01 | 65 | Equivalent | Equivalent to |
| 955.16 | Food | typhi | | | | to 200 ppm | 50, 100, 200 |
| | contact | | | | | NaOCl | NaOCl |
| | sanitizer | | | | | (passed) | |
| ASTM | EPA non- | Klebsiella | 133 | 4.89 | 37 | >99.998% | 99.9% |
| E 1153-03 | food | pneumoniae | | | | reduction | reduction |
| | contact | | | | | after 2 and 5 | |
| | sanitizer | | | | | minutes | |
| | | | | | | (passed) | |
| ASTM | EPA non- | Klebsiella | 132 | 4.86 | 36 | >99.998% | 99.9% |
| E 1153-03 | food | pneumoniae | | | | reduction | reduction |
| | contact | | | | | after 2 and 5 | |
| | sanitizer | | | | | minutes | |
| | | | | | | (passed) | |
| ASTM | EPA non- | Klebsiella | 132 | 5.01 | 33 | >99.998% | 99.9% |
| E 1153-03 | food | pneumoniae | | | | reduction | reduction |
| | contact | | | | | after 2 and 5 | |
| | sanitizer | | | | | minutes | |
| | | | | | | (passed) | |
| ASTM | EPA non- | Staphylococcus | 133 | 4.89 | 37 | >99.999% | 99.9% |
| E 1153-03 | food | aureus | | | | reduction after | reduction |
| | contact | | | | | 5 minutes | |
| | sanitizer | | | | | (passed) | |
| ASTM | EPA non- | Staphylococcus | 132 | 4.86 | 36 | >99.999% | 99.9% |
| E 1153-03 | food | aureus | | | | reduction after | reduction |
| | contact | | | | | 5 minutes | |
| | sanitizer | | | | | (passed) | |
| ASTM | EPA non- | Staphylococcus | 132 | 5.01 | 33 | >99.999% | 99.9% |
| E 1153-03 | food | aureus | | | | reduction | reduction |
| | contact | | | | | after 5 minutes | |
| | sanitizer | | | | | (passed) | |
| ASTM | EPA non- | Staphylococcus | 132 | 4.86 | 40 | >99.999% | 99.9% |
| E 1153-03 | food | aureus (MRSA) | | | | reduction | reduction |
| | contact | | | | | after 5 minutes | |
| | sanitizer | | | | | (passed) | |
| ASTM | EPA non- | Staphylococcus | 132 | 5.01 | 37 | >99.999% | 99.9% |
| E 1153-03 | food | aureus (MRSA) | | | | reduction | reduction |
| | contact | | | | | after 5 minutes | |
| | sanitizer | | | | | (passed) | |
| ASTM | EPA non- | Salmonella | 132 | 4.86 | 40 | 99.989% | 99.9% |
| E 1153-03 | food | enterica | | | | after 2 | reduction |
| | contact | | | | | minutes | |
| | sanitizer | | | | | >99.999% | |
| | | | | | | reduction | |
| | | | | | | after 5 | |
| | | | | | | minutes | |
| | | | | | | (passed) | |
| ASTM | EPA non- | Salmonella | 132 | 5.01 | 37 | 99.985% | 99.9% |
| E 1153-03 | food | enterica | | | | after 2 | reduction |
| | contact | | | | | minutes | |
| | sanitizer | | | | | >99.999% | |
| | | | | | | reduction | |
| | | | | | | after 5 | |
| | | | | | | minutes | |
| | | | | | | (passed) | |
| ASTM | EPA non- | Listeria | 132 | 4.86 | 40 | >99.998% | 99.9% |
| E 1153-03 | food | monocytogenes | | | | reduction | reduction |
| | contact | | | | | after 2 and 5 | |
| | sanitizer | | | | | minutes | |
| | | | | | | (passed) | |
| ASTM | EPA non- | Listeria | 132 | 5.01 | 37 | >99.998% | 99.9% |
| E 1153-03 | food | monocytogenes | | | | reduction | reduction |
| | contact | | | | | after 2 and 5 | |
| | sanitizer | | | | | minutes | |
| | | | | | | (passed) | |
| ASTM | EPA non- | Escherichia | 132 | 4.86 | 40 | 99.985% | 99.9% |
| E 1153-03 | food | coli | | | | after 2 | reduction |
| | contact | | | | | minutes | |
| | sanitizer | | | | | >99.999% | |
| | | | | | | reduction | |
| | | | | | | after 5 | |
| | | | | | | minutes | |
| | | | | | | (passed) | |
| ASTM | EPA non- | Escherichia | 132 | 5.01 | 37 | 99.991% | 99.9% |
| E 1153-03 | food | coli | | | | after 2 | reduction |
| | contact | | | | | minutes | |
| | sanitizer | | | | | >99.999% | |
| | | | | | | reduction | |
| | | | | | | after 5 | |
| | | | | | | minutes | |
| | | | | | | (passed) | |

### Example 6

### Hypochlorous Acid Solutions as Window Cleaner

Three different pH and FAC level hypochlorous acid solutions were aged in white opaque PET bottles and then tested as window cleaners compared to a commercial window cleaner (Windex Original Streak-free Shine Glass Cleaner manufactured by S.C. Johnson and Son) and a sodium hydroxide (NaOH) solution. The test was carried out as follows:

1. Spray test solutions on a vertical glass window and on a horizontal glass mirror.

2. Allow the surface to dry without wiping.

3. Observe level of streaking: 1=0%—no streaks; 10=100% surface is streaked.

The results are shown in Table 9.

TABLE 9
Appearance of streaks using various solutions on vertical and
horizontal glass surfaces

| | 50 ppm | 100 ppm | 200 ppm | | |
|---|---|---|---|---|---|
| | FAC Hypo- | FAC Hypo- | FAC Hypo- | | |
| | chlorous | chlorous | chlorous | | |
| | acid, aged | acid, aged | acid, aged | | |
| Solution | 144 days | 76 days | 102 days | Windex | NaOH |
| Bottle | White | White | White | — | — |
| material | opaque | opaque | opaque | | |
| | PET | PET | PET | | |
| Storage | 144 | 100 | 200 | — | — |
| time, days | | | | | |
| pH | 4.3 | 5.7 | 4.6 | 10.7 | 12.2 |
| Horizontal | 1 | 2 | 3 | 5 | 10 |
| glass | | | | | |
| Vertical | 1 | 2 | 3 | 5 | 5 |
| glass | | | | | |

The sodium hydroxide solution had the most streaks, followed by the Windex. Weaker solutions of hypochlorous acid had fewer streaks than stronger solutions of hypochlorous acid.

To test the efficacy of hypochlorous acid solution as a glass cleaner, 100 ppm FAC 5.7 pH, hypochlorous acid solution that had been stored in white opaque PET bottle for 76 days was further tested with various types of soil on a horizontal glass surface and compared to NaOH solution, and two different glass cleaners (Windex Original Streak-free Shine Glass Cleaner manufactured by S.C. Johnson and Son and Freshine solution manufactured by Aldi, Inc).

The cleaners were tested as follows:

1. Apply soil to horizontal glass surface.

2. Spray soiled area to saturate surface.

3. Allow the solution to stand for 30 seconds.

4. Wipe with a dry paper towel or lint-free cloth.

5. Observe level of streaking: 1=0%—no streaks; 10=100% surface is streaked.

The results are shown in Table 10.

TABLE 10
Comparison of various cleaning solutions on glass surface

| | Hypochlorous acid | | | |
|---|---|---|---|---|
| | 100 ppm FAC, 5.7 pH, | | | |
| | stored 76 days in | | | |
| Soil | white opaque PET | NaOH | Windex | Freshine |
| Starch | 1 | 1 | 1 | 1 |
| Butter | 1 | 3 | 2 | 4 |
| Milk | 1 | 3 | 1 | 4 |
| Mayonnaise | 1 | 2 | 3 | 4 |

The hypochlorous solution was the most effective cleaner for all types of soil tested.

### Example 7

### Hypochlorous Acid as a Concentrated Flower Life Extender Solution to be Diluted

The anti-bacterial qualities of hypochlorous acid prevent bacterial growth that prevents the cut flower from receiving an adequate supply of water and nutrients from the storage solution.

The hypochlorous acid is used as a concentrate to be diluted with tap water to maintain flower life in a retail flower shop. The anticipated use is by a florist shop to maintain freshness of their stock before they sell it. The concentrated hypochlorous acid solution has 700 to 800 ppm FAC and 4.6 to 5.6 pH. This concentrated hypochlorous acid solution is diluted with is tap water to 2% (1:50) either with a dosing pump or measuring cup. The diluted solution has 14 to 20 ppm FAC. This diluted solution extends the life of fresh cut flowers up to 14 days without changing the solution or re-trimming stems. Floral studies were done at Debbie's Floral Shop in Mundelein Ill., Karen's Floral Shop in Bolingbrook, Ill. and EIJ industries lab in Romeoville, Ill.

The experiments with the diluted hypochlorous acid solutions were compared to plain tap water and a citric acid and sugar solution (Floralife 200 solution manufactured by Floralife Inc., diluted to 1% with tap water) were carried out as follows:

1. Pour several ounces of diluted hypochlorous acid (HOCl) solution into the floral vase or container, enough to cover the flower stems by a minimum of 2 inches.

2. Remove any leaves on the flower stems inside the vase or container.

3. Cut the flower stems at an angle with scissors or knife.

4. Place the flowers in solution immediately after cutting so the stems do not dry out.

5. Add additional solution to the vase or container daily as it evaporates or is absorbed by the flower to maintain a minimum level of 2 plus inches of solution.

6. Observe the condition of the flowers.

The results are shown in Table 11. Two of the hypochlorous acid solutions were exposed to direct sun near a window during the test. The rest of the solutions were exposed to indirect sun away from the window.

TABLE 11
Condition of cut flowers in diluted hypochlorous acid solutions

| | Floralife | Tap | | | | | |
|---|---|---|---|---|---|---|---|
| | 200 | water | HOCl | HOCl | HOCl | HOCl | HOCl |
| Sun → | indirect | indirect | direct | indirect | indirect | indirect | direct |
| FAC, ppm | — | — | 41 | 90 | 90 | 102 | 160 |
| → | | | | | | | |
| FAC, ppm | — | — | 0 | 15 | 7 | 0 | 33 |
| After 13 | | | | | | | |
| days | | | | | | | |
| → | | | | | | | |
| Initial pH | 6.7 | 7.0 | 3.5 | 6.3 | 5.9 | 3.9 | 6.1 |
| → | | | | | | | |
| pH after | 8.5 | 8.4 | 3.6 | 7.9 | 6.6 | 3.7 | 7.1 |
| 13 days | | | | | | | |
| → | | | | | | | |
| Initial | — | — | 975 | 875 | 879 | 1022 | 876 |
| ORP, mV | | | | | | | |
| → | | | | | | | |
| ORP, mV | — | — | 810 | 693 | 532 | 586 | 796 |
| after 13 | | | | | | | |
| days | | | | | | | |
| → | | | | | | | |
| Days | Condition of Flowers | | | | | | |
| ↓ | | | | | | | |
| 0 | Pass | Pass | Pass | Pass | Pass | Pass | Pass |
| 1 | Pass | Pass | Pass | Pass | Pass | Pass | Pass |
| 2 | Pass | Pass | Pass | Pass | Pass | Pass | Pass |
| 5 | Fail | Fail | Pass | Pass | Pass | Pass | Pass |
| 6 | — | — | Pass | Pass | Pass | Pass | Pass |
| 7 | — | — | Pass | Pass | Pass | Pass | Pass |
| 8 | — | — | Pass | Pass | Pass | Pass | Pass |
| 9 | — | — | Pass | Pass | Pass | Pass | Pass |
| 12 | — | — | Pass | Pass | Pass | Pass | Pass |
| 13 | — | — | Pass | 25% Fail | 10% Fail | 50% Fail | Pass |
| 14 | — | — | Pass | Fail | 50% Fail | — | Pass |
| 15 | — | — | Pass | Fail | 50% Fail | — | 25% Fail |
| 30 | — | — | Pass | — | Fail | — | — |
| 31 | — | — | 25% Fail | — | — | — | — |

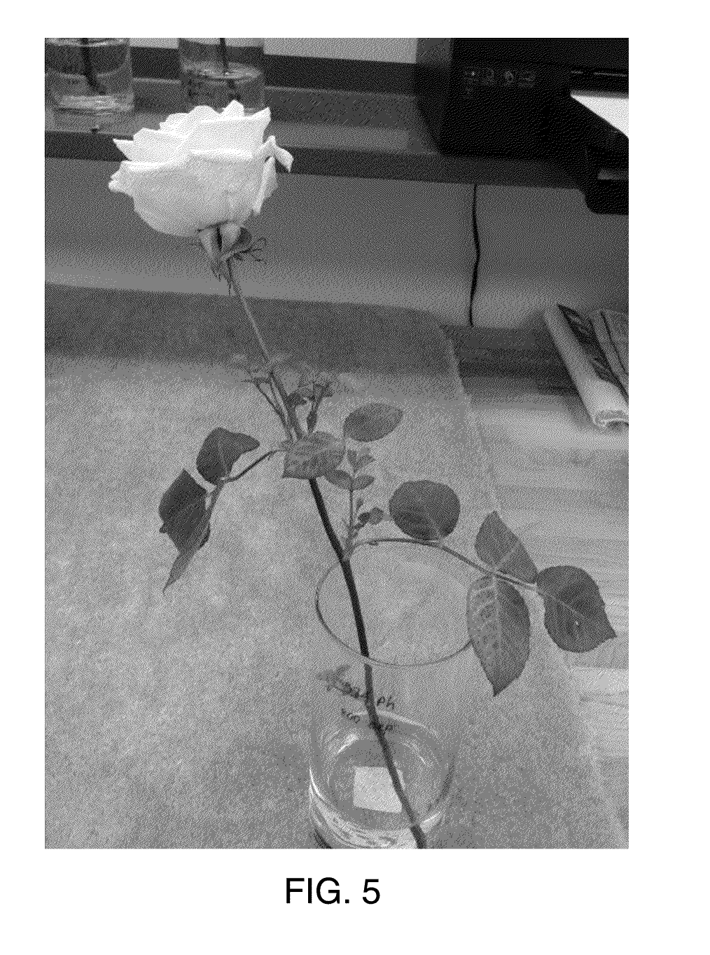

All the hypochlorous acid solutions outperformed Floralife and tap water. Flowers in the Floralife solution and the tap water failed within 5 days. All the flowers in hypochlorous acid solutions were looked fresh after 12 days. Some of the flowers started failing on the 13th day. The flower in direct sunlight and stored in hypochlorous acid looked better than all other flowers and lasted 30 days. FIG. 5 is a photograph of this flower on day 30.

Other Observations:

Differing initial pH (3.5 to 6.3), Free Available Chlorine (FAC from 41 ppm to 160 ppm) and ORP (875 to 1022 mV) of the hypochlorous acid solutions did not affect the appearance of the flowers for 12 days.

Depth of the solutions in the flower containers (2 inches and 2.8 inches) did not affect the life of the flowers.

FAC of the hypochlorous acid solutions decreased over time.

ORP of the hypochlorous acid solutions decreased over time.

pH of the tap water, Floralife and all but one of the hypochlorous acid solutions increased over time.

Leaves which fell into the vases changed the appearance of the solution from clear to hazy and reduced the life of the flower.

Approximately 25 ml of solutions were required daily to maintain the level of the solutions in the containers.

Based on these observations, a hypochlorous acid solution with an initial pH between 3.5 to 6.3 and initial FAC 41-160 ppm would extend the life of fresh cut flowers up to about 14 days.

### Example 8

### Hypochlorous Acid as a Ready to Use Solution to Extend the Life of Cut Flowers

In this case, the hypochlorous acid solution is a ready to use solution that is not intended to be diluted. It is contemplated that a customer would take home a supply of the hypochlorous acid solution with their flowers to maintain the freshness of their cut flowers.

A 196 ppm FAC, pH 6.5 solution of hypochlorous acid was compared to two commercially available products:

1. Sugar and citric acid flower food packet (Fresh Flower Food manufactured by Chrysal Columbia, S. A.) diluted in 1 liter of tap water

2. A solution of 2.5-10% aliphatic acid and <0.25% each of aliphatic hydrocarbon, halogenated aliphatic hydrocarbon and chlorinated alicyclic acid (Chrysal Clear Professional 2 New Generation manufactured by Chrysal Columbia S.A.) diluted to 1% in tap water.

The flowers placed in the Chrysal solution were pretreated by dipping the cut stems for one second into an undiluted 1-5% solution of hydroxycarballylic acid (Quick Dip 100, manufactured by FloraLife).

The comparison experiment was carried out as follows: one dozen red roses were placed into 250 ml of the test solutions, and appearance of the flowers was monitored for 14 days. The FAC, ORP and pH of each solution was recorded at the beginning and end of the experiment. All of the flowers were exposed to direct sunlight near a window.

The results are shown in Table 12.

TABLE 12
Condition of cut flowers in various solutions

| | Hypochlorous | Chrysal/ | Flower |
|---|---|---|---|
| Solution → | acid | Quick Dip 100 | Food |
| Initial FAC, ppm → | 196 | 0 | 0 |
| Final FAC, ppm → | 10 | 0 | 0 |
| Initial pH → | 6.5 | 5.7 | 5.5 |
| Final pH → | 4.1 | 6.6 | 7.1 |
| Initial ORP, mV → | 910 | 320 | 329 |
| Final ORP, mV → | 475 | 278 | 266 |
| Days ↓ | Flower Condition | | |
| 3 | Pass | Pass | 1 rose fail |
| 4 | Pass | 2 roses fail | Pass |
| 7 | Pass | 5 roses fail, | Pass |
| | | solution hazy | |
| 8 | Pass | All roses fail | Pass |
| 9 | Pass | — | Hazy solution |
| 10 | Leaves gone | — | Leaves gone |
| 14 | Fail, solution | — | Fail |
| | clear | | |

The hypochlorous acid solution performed as well as the Flower Food to maintain the cut flowers. The hypochlorous acid solution was still clear after 14 days, while the other two solutions had become hazy. About 200 ml of each solution was required to be added each day to maintain the liquid level in the flower containers. A customer would need about 1 liter of solution to last for 14 days.

### Example 9

### Hydrochlorous Acid Solution with Added Dextrose as a Cut Flower Life Extender

In this experiment, a concentrated solution of hypochlorous acid (HOCl) containing initially 700 to 800 ppm FAC and 4.0 to 5.0 pH is diluted with tap water to 2% (1:50) with a dosing pump. The diluted hypochlorous acid solution has 10 to 20 ppm FAC. This diluted hypochlorous acid solution was further mixed with 0.05, 0.1, 0.2, 0.4 and 0.5% of dextrose. The addition of dextrose to the hypochlorous acid solution is to maintain the freshness of leaves and flowers of fresh cut flowers in floral shop.

The experiment with dextrose was compared to Floralife 200 solution diluted to 1.8% (manufactured by Floralife Inc.) Chrysal solution diluted to 1% (manufactured by Chrysal Columbia S.A.), 2% diluted hypochlorous acid solution with no added dextrose and 100 ppm FAC undiluted hypochlorous acid with no added dextrose.

The flowers placed in the Chrysal solution were pretreated by dipping the cut stems for one second into undiluted Quick Dip 100 (manufactured by Floralife Inc.) before being placed into the Chrysal solution.

Stems of the flowers were cut at an angle with scissors and four red roses were placed into 200 ml each of the test solutions. Appearance of the flowers, leaves and solution was monitored for 8 days. Chrysal and Floralife solutions were changed twice and stems of the flowers were re-cut twice. None of the hypochlorous acid solutions were changed and the flowers placed in the hypochlorous acid solutions did not have the stems re-cut. About 50 ml of each of the test solutions were added each day to maintain the liquid level in the vases.

The results are shown in Table 13. All the solutions were exposed to indirect sun light away from the window.

TABLE 13
Conditions of cut flowers in various solutions

| | | | 2% | | 2% | 2% | 2% | 2% | 2% |
|---|---|---|---|---|---|---|---|---|---|
| | | | diluted | 100 ppm | diluted | diluted | diluted: | diluted | diluted |
| | | | HOCl, | HOCl, | HOCl, | HOCl, | HOCl, | HOCl, | HOCl, |
| | Chrysal/ | Floralife | 0% | 0% | 0.05% | 0.1% | 0.2% | 0.4% | 0.5% |
| Test solution → | Quick dip | 200 | dextrose | dextrose | dextrose | dextrose | dextrose | dextrose | dextrose |
| Initial FAC, ppm | 0 | 0 | 18 | 92 | 16 | 17 | 17 | 16 | 14 |
| Final FAC, ppm | 0 | 0 | 3 | 27 | 2 | 2 | 1.2 | 1.8 | 0 |
| Initial ORP, mV | NA | NA | 738 | 901 | 725 | 732 | 753 | 752 | 791 |
| Final ORP, mV | NA | NA | 622 | 736 | 630 | 640 | 632 | 605 | 608 |
| Initial pH | 4.9 | 3.7 | 7.1 | 5.8 | 7.1 | 7.2 | 7.1 | 7.1 | 7.2 |
| Final Ph | 5.4 | 2.4 | 7.0 | 4.5 | 7.1 | 7.0 | 7.1 | 7.2 | 7.2 |
| Days↓ | Flower Condition | | | | | | | | |
| 3 | Pass | Pass | Pass | Pass | Pass | Pass | Pass | Pass | Pass |
| 4 | Pass | Pass | Pass | Pass | Pass | Pass | Pass | Pass | Pass |
| 7 | Flowers | Flowers | Flowers | Flowers | Flowers | Flowers | One | All | All |
| | failed/ | failed/ | pass/ | pass/ | pass/ | pass/ | flower | flowers | flowers |
| | Green | Green | Light | Light | Light | Green | failed/ | failed/ | failed/ |
| | leaves | leaves/ | yellow | yellow | yellow | leaves | Green | Green | Green |
| | | Hazy | leaves | leaves | leaves | | leaves | leaves | leaves/ |
| | | solution | | | | | | | Light hazy |
| | | | | | | | | | solution |
| 8 | Flowers | Flowers | Flowers | Flowers | Flowers | Flowers | One flower | All | All |
| | failed/ | failed/ | pass/ | pass/ | pass/ | pass/ | failed/ | flowers | flowers |
| | Green | Green | Light | Light | Light | Green | Green | failed/ | failed/ |
| | leaves/ | leaves/ | yellow | yellow | yellow | leaves/ | leaves/ | Green | Green |
| | Clear | Hazy | leaves/ | leaves/ | leaves/ | Clear | Clear | leaves/ | leaves/ |
| | solution | solution | Clear | Clear | Clear | solution | solution | Clear | Slight hazy |
| | | | solution | solution | solution | | | solution | solution |

Hypochlorous acid solution diluted to 2% with 0.1% added dextrose performed better than all other test solutions with bright flowers, clear solution and green leaves even after 8 days.

With no added dextrose in the diluted and undiluted hypochlorous acid solutions, the flowers remained healthy and the solution remained clear after 8 days, but the leaves turned light yellow after 7 days.

At 0.2% added dextrose in the diluted hypochlorous acid solution, one flower failed at 7 days, but the leaves remained green and the solution remained clear after 8 days.

As the concentration of dextrose in the hypochlorous acid increased to 0.4% and 0.5%, the flowers failed after 7 days and the solutions turned slightly hazy but the leaves stayed green.

When the concentration of dextrose in the 2% diluted hypochlorous acid was 0.05%, the flowers remained healthy for 8 days but the leaves turned light yellow with clear solution. Flowers in Chrysal and Floralife solutions failed on the 7th day.

### Example 10

### Accelerated Aging and Corrosion Characteristics of Improved Shelf Life Hypochlorous Acid at 54° C.

In this example, solutions of hypochlorous acid are tested at an elevated temperature to determine their stability. This accelerated aging protocol is based on EPA Guidelines 830.6317 and 830.6320 Accelerated Storage Stability and Corrosion Characteristics Study Protocol Attachment A for accelerated testing of pesticides, in which 14 days storage at 54° C. was determined to correlate to the degradation that can be expected after a year of storage at room temperature. The accelerated aging is carried out for 14 days at a controlled temperature of 54° C.±2° C. The hypochlorous acid solutions are aged in containers made of various materials in a constant-temperature incubator (VWR model number 1510 E).

The procedure is as follows:

1. Turn on the incubator and set the temperature to 54° C.

2. Fill up the test containers with hypochlorous acid solutions, without rinsing them and cap the containers.

3. Record the initial percent FAC and initial filled container weight, for time=0.

4. Place the containers with hypochlorous acid solution in the incubator for 14 days at 54° C. and check the temperature each day for 14 days. Temperature must be 54° C.±2° C. each day to continue testing.

5. At the end of 14 days record the weight of the container with solution, % FAC, changes in color, phase separation and physical changes to appearance of the containers and the solutions.

Two different concentrations of hypochlorous acid were produced for these tests, using the first embodiment production scheme described in Example 1. The production process conditions are shown in Table 14.

TABLE 14
Hypochlorous acid solutions production process
conditions

| Amps DC | pH set point | FAC (ppm) |
|---|---|---|
| 54 | 5.0 | 200 |
| 95 | 5.0 | 460 |

The results of accelerated aging at 54° C. and corrosion characteristics for these two concentrations of hypochlorous acid in 32 ounce white opaque PET bottles, Scholle ½ gallon Nylon/PE bag in a box (Scholle Product 200005) and Rapak ½ gallon Nylon/PE bag in a box (D.S. Smith Plastics) are shown in Table 15. The white opaque PET bottles are manufactured with 2-3% TiO₂ to provide opacity. The details of these containers are shown in Table 3, as shown on page 31.

TABLE 15
Accelerated aging of hypochlorous acid solutions in various
containers for 14 days at 54° C.

| | 32 oz. | 32 oz. | Scholle | RaPak |
|---|---|---|---|---|
| | white | white | ½ gallon | ½ gallon |
| | opaque | opaque | Nylon/ | Nylon/ |
| | PET | PET | PE bag | PE bag |
| Container type | bottle | bottle | in a box | in a box |
| Initial FAC, ppm | 200 | 460 | 200 | 460 |
| Final FAC, ppm | 170 | 455 | 150 | 320 |
| Change in FAC, | 30 | 5 | 50 | 140 |
| ppm | | | | |
| Percent change | 15% drop | 1% drop | 25% drop | 30% drop |
| in FAC | (pass) | (pass) | (fail) | (fail) |
| Initial filled | 1181.7 | 1181.7 | 3818 | 3818 |
| container | | | | |
| weight, grams | | | | |
| Final filled | 1181.5 | 1181.5 | 3818 | 3818 |
| container | | | | |
| weight, grams | | | | |
| Phase | none | none | none | none |
| Separation | | | | |
| Color Change | none | none | none | none |
| of Solution | | | | |
| Leaks in | none | none | none | none |
| Container | | | | |
| Appearance of | Pass, | Pass, | Pass, | Pass, |
| Container | no | no | no | no |
| | corrosion, | corrosion, | corrosion, | corrosion, |
| | cracking | cracking | cracking | cracking |
| | or rust | or rust | or rust | or rust |

For both initial concentrations of hypochlorous acid, the solutions in the white opaque PET containers dropped less than 20% of FAC in this accelerated aging, and therefore passed the test. The solutions of hypochlorous acid stored in the Nylon/PE bags in a box exhibited unacceptable drops (more than 20%) of FAC and therefore failed this accelerated aging test. The white opaque PET containers thus contribute significantly to the enhanced shelf life of hypochlorous acid.

Further, the more concentrated solutions of hypochlorous acid lost much less free available chlorine than the less concentrated solutions, showing that more concentrated solutions of hypochlorous acid are even more suitable for long-term storage in white opaque PET bottles.

### Example 11

### Accelerated Aging of Hypochlorous Acid Solutions at 45° C.

In this example, solutions of hypochlorous acid prepared according to the production scheme detailed in Example 1 are aged at 45° C. to simulate longer term storage at room temperature. Table 16 is used to correlate the storage time at 45° C. to storage time at 23° C. room temperature. The correlation of Table 16 assumes that the rate of the decomposition reaction depends on temperature according to the Arrhenius equation and that the rate of reaction quadruples for every 10° C. increase in temperature.

TABLE 16
Equivalent storage times at 23° C.
and 45° C. for accelerated aging

| Days at 23° C. | Days at 45° C. |
|---|---|
| 365 (1 year) | 17 |
| 730 (2 years) | 35 |
| 1095 (3 years) | 52 |
| 1460 (4 years) | 69 |
| 1825 (5 years) | 87 |

Accelerated aging of hypochlorous acid solutions were carried out as follows:

1. Turn on VWR model number 1510 E incubator and set the temperature to 45° C.

2. Fill up the test containers with hypochlorous acid solutions without rinsing the containers.

3. Record the initial concentration, ppm FAC

4. Place the containers with hypochlorous acid solution in the VWR incubator at 45° C. and check the temperature each day. Temperature must be 45° C.±2° C. each day to continue testing.

5. Test concentration in ppm FAC until FAC has dropped more than 10 percent of the initial FAC.

6. Use Table 16 to determine equivalent times at 23° C.

The results of accelerated aging at 45° C. of two different solutions of hypochlorous acid stored in white opaque PET bottles are shown in Table 17. The PET bottles are made with 2-3% TiO₂.

TABLE 17
Accelerated aging of hypochlorous acid stored at 45° C. in
white opaque PET bottles

| | Equivalent | | | | |
|---|---|---|---|---|---|
| Days at | months at | FAC, | Percent | FAC, | Percent |
| 45° C. | 23° C. | ppm | drop FAC | ppm | drop FAC |
| 0 | 0 | 196 | 0 | 505 | 0 |
| 9 | 7 | 182 | 7.14 | 477.5 | 5.45 |
| 18 | 12.6 | 179 | 8.67 | 465 | 7.92 |
| 27 | 18.9 | 171.5 | 12.5 | 453 | 10.3 |
| 32 | 22.4 | 167.5 | 14.54 | 445 | 11.88 |
| 35 | 24 | 165 | 15.82 | 443 | 12.28 |

| | | |
|---|---|---|
| Phase separation | None | None |
| Color change | None | None |
| Leak | None | None |
| Appearance of | Pass, no corrosion, | Pass, no corrosion, |
| Container | cracking or rust | cracking or rust |

These results show that the shelf life of both 200 ppm and 500 ppm FAC hypochlorous acid is more than 2 years at 23° C. when stored in white opaque PET bottles colored with 2-3% TiO₂.

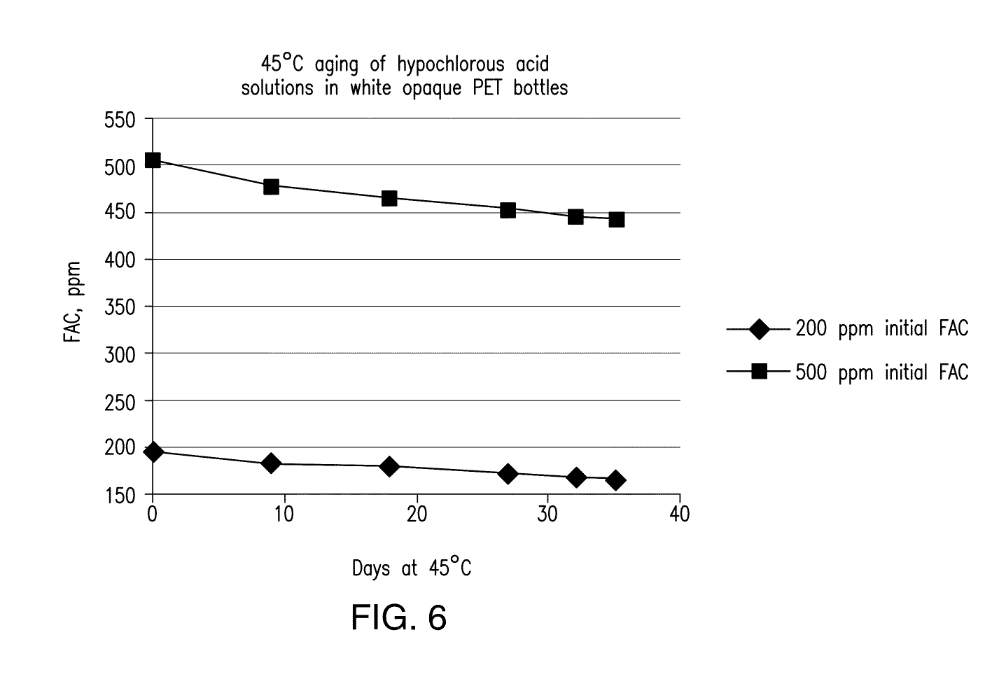

The accelerated aging results at 45° C. for these two solutions of hypochlorous acid stored in white opaque PET containers are plotted in FIG. 6.

### Example 12

### Second Embodiment Production of Extended Life Hypochlorous Acid

In this second embodiment production scheme for extended life hypochlorous acid, the major difference is that a cation exchange membrane comprised of Nation is used in the electrolytic cell, rather than a bipolar membrane as described in Example 1.

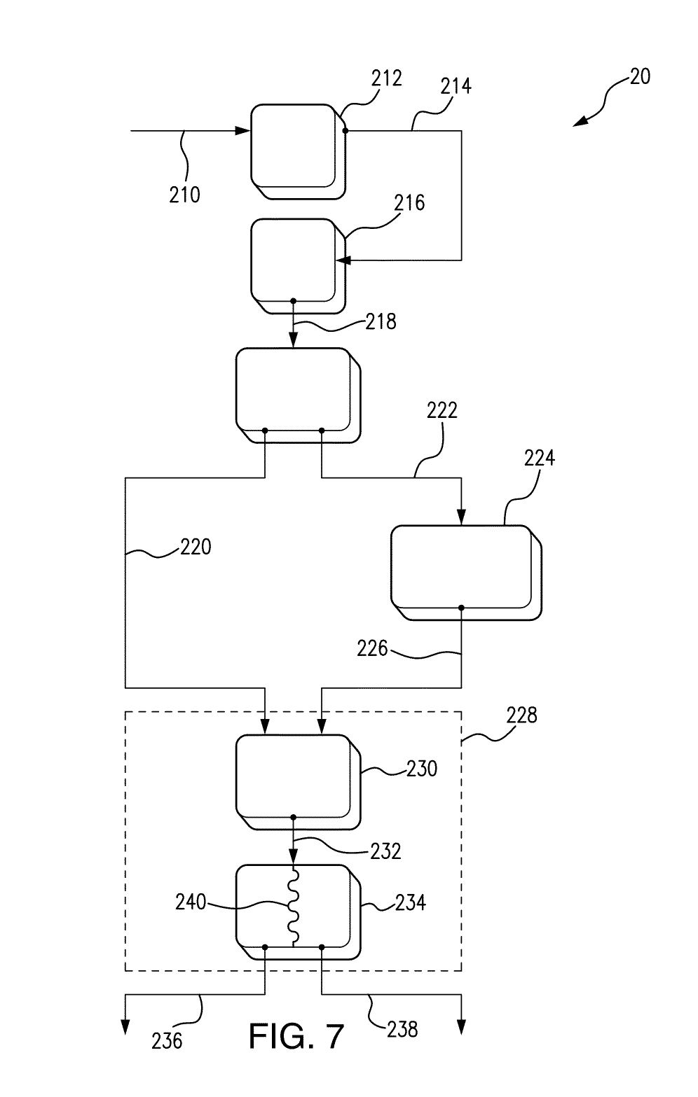

FIG. 7 shows a process flow diagram for a second embodiment production system 20 for improved shelf life hypochlorous acid.

In the production system 20, tap water 210 flows to the water softener system 212 where calcium (Ca) and magnesium (Mg) ions are removed. The water softener system reduces the hardness of the water to 0 ppm. A softened water stream 214 emerges from the water softener 212 and enters a reverse osmosis system 216. Softened, purified water 218 flows from the reverse osmosis system 216 and is separated into a first stream 220 and a second stream 222. Second stream 222 is combined with 99.9% pure food grade salt 224 (Morton Culinox 999) and emerges as a 26% saturated salt solution 226. The first stream 220 of purified water and the 26% saturated salt solution 226 enter an electrolysis system 228.

The electrolysis system 228 comprises a mixing stage 230, and an electrolysis stage 234.

The mixing stage 230 combines the streams 220 and 226 into a diluted salt solution 232. The mixing stage 230 is constructed and arranged to be able to produce varying concentrations of the diluted salt solution 232. The diluted salt solution 232 then flows to the electrolysis stage 234 to produce a hypochlorous acid solution stream 236 and a sodium hydroxide solution 238.

The electrolysis stage 234 is constructed and arranged to be able to produce varying concentrations and pH of the hypochlorous acid solution 236. The electrolysis stage 234 utilizes a cation exchange membrane (made of Nafion) 240 in the production of the hypochlorous acid solution 236 and the sodium hydroxide solution 238.

The hypochlorous acid solution 236 is bottled. The hypochlorous acid solution 236 is less than 110° F. when it emerges from the electrolysis system 228.

This production scheme 20 can produce up to 1200 gallons per hour of hypochlorous acid solution and 300 gallons per hour of sodium hydroxide solution.

Other Uses of Extended Storage Life Hypochlorous Acid

Hypochlorous acid is known to deactivate or kill Anaerobic sulfate reducing bacteria (SRB) in oil fields as well as Staphylococcus, Streptococcus, E. coli, Cryptosporidium, Giardia Lamblia, Listeria and Legionella. Therefore, the extended storage life hypochlorous acid is suitable to be used as a biocide for the following applications.

For typical fracking water treatment, mix 2.5-10 gallons of 200-700 ppm FAC hypochlorous acid solution stored in a white opaque PET container with 1000 gallons of fracking water to make 2 ppm FAC which will reduce and control the growth of non-public health bacteria to protect fracturing fluids and polymers.

For produced water treatment, mix 13.5-50 gallons of 200-700 ppm FAC hypochlorous acid solution stored in a white opaque PET container with 1000 gallons of produced water to make 9.5 ppm FAC to reduce and control the growth of non-public health bacteria and odor.

For water flood injection treatment, mix 13.5-50 gallons of 200-700 ppm FAC hypochlorous acid solution stored in a white opaque PET container with 1000 gallons of injection water to make 9.5 ppm FAC to reduce and control the growth of non-public health bacteria.

For sour oil well water treatment, slug dose 96-336 gallons of 200-700 ppm FAC hypochlorous acid stored in a white opaque PET container into the well bore on a daily or weekly basis to reduce and control the growth of non-public health bacteria, reduce hydrogen sulfide gas and restore well integrity.

For typical hydrocarbon storage facilities and gas storage facility treatment, mix 70-252 gallons of 200-700 ppm FAC hypochlorous acid solution stored in a white opaque PET container into the water phase of the mixed hydrocarbon/water system to reduce the growth of non-public health bacteria, control the formation of hydrogen sulfide gas and reduce corrosion of storage tanks.

For typical oil and gas transmission line treatment, slug dose 120-420 gallons of 200-700 ppm FAC hypochlorous acid solution stored in a white opaque PET container into the transmission line on a daily or weekly basis to control the growth of non-public health bacteria such as anaerobic sulfate-reducing bacteria (SRB) and reduce microbiologically influenced corrosion (MIC).

For typical metal working fluid water treatment as a tank side biocide, mix 6.5-25 gallons of 200-700 ppm FAC hypochlorous acid solution stored in an opaque PET container for 500 gallons of metalworking fluid sump to make 9.5 ppm FAC to reduce and control the growth of non-public health bacteria and odor.

To prevent and control the growth of odor causing bacteria in sponges, spray sponge with 200-700 ppm FAC hypochlorous acid solution stored in an opaque PET container until saturated. Let it stand for 5 minutes.

For typical cooling tower water treatment, mix 13.5-50 gallons of 200-700 ppm FAC hypochlorous acid solution stored in an opaque PET container per 1000 gallons of cooling tower water to make 9.5 ppm FAC to reduce and control the growth of non-public health bacteria and odor.

For typical fish tank water treatment, mix 3 ounces of 100-225 ppm FAC hypochlorous acid solution stored in an opaque PET container per 2.5 gallons of fish tank water to 1 to 2 ppm FAC to reduce algae and bacteria growth.

For typical treatment of lazy river and swimming pool water, mix 4-16 gallons of 200-700 ppm FAC hypochlorous acid solution stored in an opaque PET container per 1000 gallons of water to make 3 ppm FAC to reduce and control bacteria, algae and biofilm.

For typical treatment of process water system (not potable water), mix 20 gallons of 200 ppm FAC hypochlorous acid solution stored in an opaque PET container with 1000 gallons of process water to 4 ppm FAC to reduce and control bacteria, slime and biofilm.

For typical treatment of potable water system, mix 5.5-16 gallons of 200-700 ppm FAC hypochlorous acid solution stored in an opaque PET bottle with 1000 gallons of drinking water to make 3 ppm FAC to reduce and control bacteria, slime and biofilm.

For typical treatment of portable humidifier water, mix 5-20 ounces of 200-700 ppm FAC hypochlorous acid solution stored in an opaque PET container per 10 gallons of humidifier water to make 3 ppm FAC to reduce and control bacteria, slime and biofilm.

While the forgoing examples describe using 200 ppm FAC hypochlorous acid as a treatment, it is understood that 200-700 ppm hypochlorous acid solutions stored in opaque PET containers may be diluted as necessary to provide adequate biocide activity.

Further, while the forgoing examples utilize white opaque PET containers with 2-3% TiO₂ added to provide opacity, it is understood that any suitable filler or coloring agent comprising, but not limited to carbon black, calcium carbonate, clay, barium sulfate, zinc oxide, colorants and the like may be used to provide suitable opacity to the PET containers for extended storage life hypochlorous acid and that the containers need only be opaque, not white.

Thus, the invention provides a process of making extended storage life hypochlorous acid and methods of storing and using the extended storage life hypochlorous acid.

The described embodiments are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. A method for producing a shelf stable hypochlorous acid solution comprising:
treating tap water through a water softener to produce softened water having hardness less than 40 ppm;
treating the softened water through a reverse osmosis system to produce softened purified water having less than 40 ppm alkalinity and less than 80 ppm total dissolved solids;
combining the softened purified water with at least 99% pure sodium chloride to form a saline process solution;
electrolyzing the saline process solution by passing the saline process solution through a chamber having an anode positioned on an anode side and a cathode positioned on a cathode side, the anode side and the cathode side being separated by a membrane constructed and arranged to only permit the migration of chemical ions in one direction therethrough;
whereby a hypochlorous acid solution is formed on the anode side and a sodium hydroxide is formed on the cathode side and;
the hypochlorous acid solution is directed to containers for distribution.

2. The method for producing a shelf stable hypochlorous acid solution of claim 1, wherein the containers are comprised of polyethylene terephthalate (PET).

3. The method for producing a shelf stable hypochlorous acid solution of claim 1, wherein the containers are opaque.

4. The method for producing a shelf stable hypochlorous acid solution of claim 2, wherein the (PET) containers are opaque.

5. The method for producing a shelf stable hypochlorous acid solution of claim 2, wherein the (PET) containers are opaque white.

6. The method for producing a shelf stable hypochlorous acid solution of claim 2, wherein the (PET) containers contain between 2% and 3% TiO₂.

7. The method for producing a shelf stable hypochlorous acid solution of claim 4, wherein the (PET) containers contain between 2% and 3% TiO₂.

8. The method for producing a shelf stable hypochlorous acid solution of claim 5, wherein the (PET) containers contain between 2% and 3% TiO₂.

9. A hypochlorous acid solution having free available chlorine (FAC) content less than 700 ppm, pH less than 7, hardness less than 40 ppm, alkalinity less than 40 ppm and total dissolved solids less than 80 ppm;
wherein the hypochlorous acid solution is stored in opaque containers;
whereby the FAC retention is greater than 80% after 2 months of storage at room temperature.

10. The hypochlorous acid solution of claim 9, the FAC retention further being greater than 90% after 2 months of storage at room temperature.

11. The hypochlorous acid solution of claim 9, the FAC retention further being greater than 80% after 2 years of storage at room temperature.

12. The hypochlorous acid solution of claim 9, the solution further being formulated for use as a cleaner for smooth surfaces.

13. The hypochlorous acid solution of claim 9, the solution further being formulated for use as a cut flower life extender and the solution further comprising 0 to 0.2% added dextrose.

14. The hypochlorous acid solution of claim 9, the solution further being formulated for use as a hospital disinfectant.

15. The hypochlorous acid solution of claim 9, the solution further being formulated for use as a deodorizer.

16. The hypochlorous acid solution of claim 9, the solution further comprising FAC range 40-800 ppm.

17. The hypochlorous acid solution of claim 9, the solution further comprising FAC range 300-550 ppm.

18. The hypochlorous acid solution of claim 9, the solution further comprising FAC range 125-300 ppm.

19. The hypochlorous acid solution of claim 9, the solution further comprising pH range 3.0-7.0.

20. A hypochlorous acid solution comprising (FAC) range from 70-800 ppm, pH range from 4.0-5.6, hardness less than 20 ppm, alkalinity less than 20 ppm and total dissolved solids less than 50 ppm;
wherein the hypochlorous acid solution is stored in white opaque (PET) containers containing between 2% and 3% TiO₂;
whereby the FAC retention is greater than 80% after 2 years of storage at room temperature.
